(19) United States
(12) Patent Application Publication
(10) Pub. No.: US 2025/0111790 A1
(43) Pub. Date: Apr. 3, 2025

(54) FLIGHT MANAGEMENT SYSTEM, FLIGHT MANAGEMENT METHOD, AND RECORDING MEDIUM

(71) Applicant: NEC Corporation, Minato-ku, Tokyo (JP)

(72) Inventors: Eiichi Tokumi, Tokyo (JP); Takuya Hisamoto, Tokyo (JP); Kenichi Kijima, Tokyo (JP); Tetsuya Tanabiki, Tokyo (JP); Takahiro Mizuta, Tokyo (JP); Takuya Nomura, Tokyo (JP)

(73) Assignee: NEC Corporation, Minato-ku, Tokyo (JP)

(21) Appl. No.: 18/834,682

(22) PCT Filed: Mar. 24, 2022
(86) PCT No.: PCT/JP2022/013966

§ 371 Date: Jul. 31, 2024

(51) Int. Cl. G08G 5/34; G08G 5/26; G08G 5/54; G08G 5/56; G08G 5/57; G08G 5/58

(52) U.S. Cl. CPC G08G 5/34; G08G 5/26; G08G 5/54; G08G 5/56; G08G 5/57; G08G 5/58

(57) ABSTRACT

A flight management system that manages flight of an unmanned aircraft flying according to a flight plan. The flight management system including at least one unmanned aircraft that holds shared information in which transmission information including identification information, position information, and time information about the unmanned aircraft and flight plan information including a flight plan are associated with each other and that flies according to the flight plan while transmitting the transmission information at a predetermined timing, and a flight management device that shares the shared information with the unmanned aircraft to be managed and that acquires the transmission information transmitted from the unmanned aircraft flying according to the flight plan to update the shared information.

### TECHNICAL FIELD

The present disclosure relates to a flight management system and the like that manage flight of an unmanned aerial vehicle.

### BACKGROUND ART

Technologies for utilizing drones (also referred to as unmanned aerial vehicles) in applications such as distribution and infrastructure inspection and monitoring have been developed. For example, efforts have been made mainly in the country to achieved beyond-visual flight of the unmanned aerial vehicle in a manned zone (above a third party). In Japan, beyond-visual flight of unmanned aerial vehicles is allowed from 2022. The beyond-visual flight corresponds to the highest level of level 4 among the flight levels of the unmanned aerial vehicle defined by the Ministry of Land, Infrastructure, Transport and Tourism. In Japan, airframe registration of unmanned aerial vehicles will become mandatory from June 2022. Accordingly, mounting of a remote identifier (ID) device on the unmanned aerial vehicle is mandatory. The remote ID device is a transmitter that transmits transmission information (also referred to as remote ID information) including a remote ID for managing flight of the unmanned aerial vehicle. The remote ID information includes an identifier, position information, and time information (also referred to as a time stamp) of the unmanned aerial vehicle.

There is a need to monitor the flight status of the unmanned aerial vehicle by a means other than visual observation and to manage flight of the unmanned aerial vehicle in accordance with the release of the restriction on the beyond-visual flight of the unmanned aerial vehicle. In such flight management, it is required to accurately grasp a situation such as whether the unmanned aerial vehicle is flying according to the flight plan or is flying out of the flight plan. For example, when the position information and the time information included in the remote ID are used, the flight management of the unmanned aerial vehicle can be performed by acquiring the position of the unmanned aerial vehicle associated with the time.

PTL 1 discloses a technique related to processing of a flight mission of an unmanned aerial vehicle. In the method of PTL 1, flight data is retrieved in response to a load request for the flight data. In the method of PTL 1, flight data retrieved in response to a load request is loaded, and an aircraft to be controlled is controlled to execute a flight mission related to the flight data.

### CITATION LIST

### Patent Literature

PTL 1: JP 2017-502397 A

### SUMMARY OF INVENTION

### Technical Problem

In the method of PTL 1, a flight mission of an unmanned aerial vehicle is processed using flight data recorded in advance. Therefore, it is not possible to accurately grasp the change related to the flight status for each unmanned aerial vehicle. In the method of PTL 1, even when the unmanned aerial vehicle is not flying according to the flight mission related to the flight data, when the departure place/departure time and the arrival place/arrival time match, it is determined that the flight mission has been executed as scheduled. Therefore, the method of PTL I cannot accurately manage the flight situation including the flight route of the unmanned aerial vehicle.

An object of the present disclosure is to provide a flight management device and the like capable of accurately managing a flight situation of an unmanned aircraft.

### Solution to Problem

A flight management system according to an aspect of the present disclosure manages flight of an unmanned aircraft flying according to a flight plan, the flight management system including at least one unmanned aircraft that holds shared information in which transmission information including identification information, position information, and time information about the unmanned aircraft and flight plan information including a flight plan are associated with each other and that flies according to the flight plan while transmitting the transmission information at a predetermined timing, and a flight management device that shares the shared information with the unmanned aircraft to be managed and that acquires the transmission information transmitted from the unmanned aircraft flying according to the flight plan to update the shared information.

A flight management method according to an aspect of the present disclosure manages flight of an unmanned aircraft that flies according to a flight plan, the flight management method including, a flight management device sharing shared information in which transmission information including identification information, position information, and time information about the unmanned aircraft to be managed and flight plan information including a flight plan are associated with each other with the unmanned aircraft, acquiring the transmission information transmitted from the unmanned aircraft that flies according to the flight plan while transmitting the transmission information at a predetermined timing, and updating the shared information using the acquired transmission information.

A program according to an aspect of the present disclosure manages flight of an unmanned aircraft that flies according to a flight plan, the program causing a computer to execute the steps of sharing shared information in which transmission information including identification information, position information, and time information about the unmanned aircraft to be managed and flight plan information including a flight plan are associated with each other with the unmanned aircraft, acquiring the transmission information transmitted from the unmanned aircraft that flies according to the flight plan while transmitting the transmission information at a predetermined timing, and updating the shared information using the acquired transmission information.

### Advantageous Effects of Invention

According to the present disclosure, it is possible to provide a flight management device and the like capable of accurately managing a flight situation of an unmanned aircraft.

### BRIEF DESCRIPTION OF DRAWINGS

FIG. 1 is a block diagram illustrating an example of a configuration of a flight management system according to a first example embodiment.

FIG. 2 is a conceptual diagram illustrating an example of a flight route on which the unmanned aircraft to be managed of the flight management system according to the first example embodiment flies.

FIG. 3 is a block diagram illustrating an example of a configuration of a flight management device included in the flight management system according to the first example embodiment.

FIG. 4 is a table illustrating an example of shared information shared by the flight management system according to the first example embodiment.

FIG. 5 is a table illustrating an example of shared information shared by the flight management system according to the first example embodiment.

FIG. 6 is a block diagram illustrating an example of a configuration of an operation device included in the flight management system according to the first example embodiment.

FIG. 7 is a conceptual diagram illustrating an example of a configuration of an unmanned aircraft included in the flight management system according to the first example embodiment.

FIG. 8 is a block diagram illustrating an example of a configuration of an unmanned aircraft included in the flight management system according to the first example embodiment.

FIG. 9 is a conceptual diagram for describing a flight route on which the unmanned aircraft to be managed of the flight management system according to the first example embodiment flies.

FIG. 10 is a table illustrating an example of shared information shared by the flight management system according to the first example embodiment.

FIG. 11 is a table illustrating an example of shared information shared by the flight management system according to the first example embodiment.

FIG. 12 is a table illustrating an example of shared information shared by the flight management system according to the first example embodiment.

FIG. 13 is a flowchart for describing an example of the operation of the flight management device included in the flight management system according to the first example embodiment.

FIG. 14 is a flowchart for describing an example of an operation in response to an input of flight plan information by the operation device included in the flight management system according to the first example embodiment.

FIG. 15 is a flowchart for describing an example of an operation at the time of executing a flight plan by the operation device included in the flight management system according to the first example embodiment.

FIG. 16 is a flowchart for describing an example of an operation at the time of executing a flight plan by an unmanned aircraft included in the flight management system according to the first example embodiment.

FIG. 17 is a flowchart for describing an example of a flight control process by the unmanned aircraft included in the flight management system according to the first example embodiment.

FIG. 18 is a block diagram illustrating an example of a configuration of a flight management system according to a second example embodiment.

FIG. 19 is a conceptual diagram for describing an example in which a plurality of unmanned aircrafts flies according to a guidance signal transmitted from an operation device included in the flight management system according to the second example embodiment.

FIG. 20 is a conceptual diagram for describing an example in which a plurality of unmanned aircrafts flies according to a guidance signal transmitted from an operation device included in the flight management system according to the second example embodiment.

FIG. 21 is a flowchart for describing an example of an operation at the time of executing a flight plan by the operation device included in the flight management system according to the second example embodiment.

FIG. 22 is a flowchart for describing an example of a flight control process by the unmanned aircraft included in the flight management system according to the second example embodiment.

FIG. 23 is a block diagram illustrating an example of a configuration of a flight management system according to a third example embodiment.

FIG. 24 is a conceptual diagram for describing an example of cooperative control by a plurality of unmanned aircrafts included in the flight management system according to the third example embodiment.

FIG. 25 is a conceptual diagram for describing an example of cooperative control by a plurality of unmanned aircrafts included in the flight management system according to the third example embodiment.

FIG. 26 is a flowchart for describing an example of a flight control process by the unmanned aircraft included in the flight management system according to the third example embodiment.

FIG. 27 is a flowchart for describing an example of a flight control process by the unmanned aircraft included in the flight management system according to the second example embodiment.

FIG. 28 is a block diagram illustrating an example of a configuration of a flight management system according to a fourth example embodiment.

FIG. 29 is a block diagram illustrating an example of a hardware configuration that implements control and processing of the flight management system according to each example embodiment.

### EXAMPLE EMBODIMENT

Hereinafter, embodiments of the present invention will be described with reference to the drawings. However, the example embodiments described below have technically preferable limitations for carrying out the present invention, but the scope of the present invention is not limited to the following. In all the drawings used in the following description of the example embodiment, the same reference numerals are given to the same parts unless there is a particular reason. In the following example embodiments, repeated description of similar configurations and operations may be omitted.

### First Example Embodiment

First, a flight management system according to a first example embodiment will be described with reference to the drawings. The flight management system according to the present example embodiment manages flight of an unmanned aerial vehicle such as a flying drone. Hereinafter, the unmanned aerial vehicle is referred to as an unmanned aircraft. The unmanned aircraft may travel on the ground or navigate on or under water as long as it can be remotely operated. In the present example embodiment, the flight of a flying type unmanned aircraft will be described.

### (Configuration)

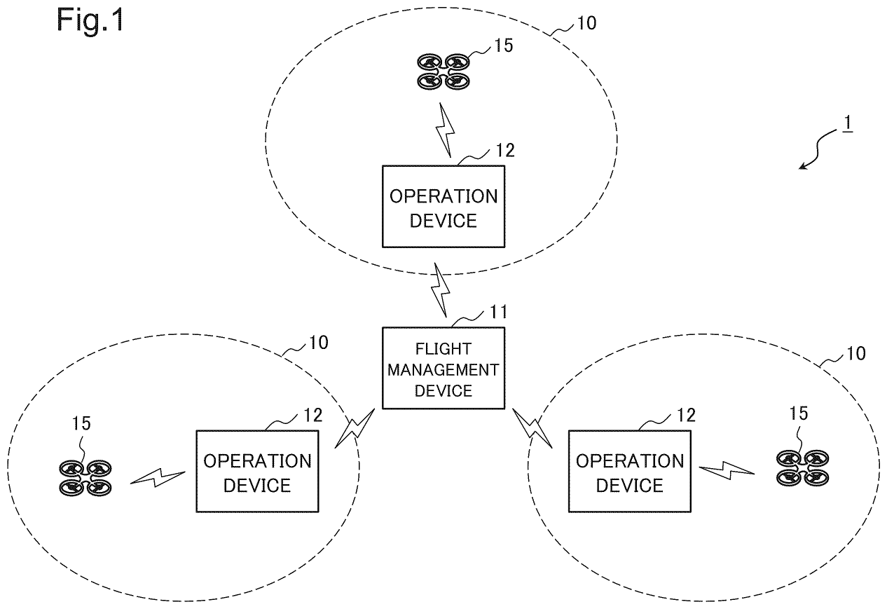

FIG. 1 is a conceptual diagram illustrating an example of a configuration of a flight management system 1 according to the present example embodiment. The flight management system 1 includes a flight management device 11, an operation device 12, and an unmanned aircraft 15. FIG. 1 illustrates three sets of combinations (also referred to as flight unit 10) of the operation device 12 and the unmanned aircraft 15. The number of the flight units 10 is not limited to three. The number of the flight units 10 may be one, two, or four or more. In each of the flight units 10, for at least one of the operation device 12 and the unmanned aircraft 15, the number may be plural.

The flight management device 11 manages flight of the unmanned aircraft 15 to be managed. The flight management device 11 is communicably connected to the operation device 12. The flight management device 11 communicates with the unmanned aircraft 15 via the operation device 12. For example, the flight management device 11 is wirelessly connected to the operation device 12. For example, the flight management device 11 is connected to the operation device 12 via a high-speed communication line such as long term evolution (LTE), fourth generation mobile communication, or fifth generation mobile communication. For example, flight management device 11 may be connected to the operation device 12 by a wired cable. Connection between flight management device 11 and operation device 12 is not particularly limited. The flight management device 11 may manage the flight of the unmanned aircraft 15 in real time, or may manage the performance result of the flight plan by the unmanned aircraft 15 that has completed the flight plan.

The flight management device 11 acquires information (also referred to as flight plan information) on a flight plan related to the flight of each unmanned aircraft 15. The flight management device 11 acquires flight plan information from the operation device 12. The flight plan information is generated for each flight plan of the unmanned aircraft 15. The flight plan information includes an identifier (flight plan ID) of a flight plan, a departure place, a scheduled departure time, a destination place, a scheduled arrival time, and the like. The flight plan information may include information (also referred to as route information) regarding a flight route from a departure place to a destination place. For example, the flight plan information may include information about a relay point (also referred to as a way point) in the flight route from the departure place to the destination place. In a case where the flight route is long, relay point information (also referred to as way point information) including a relay point and a scheduled passing time of a mid-term plan point is preferably included in the flight plan information. In the present example embodiment, an example in which flight plan information is input from the operation device 12 will be described. The flight plan information may be input to the flight management device 11 via an input device (not illustrated).

The flight management device 11 acquires transmission information (also referred to as remote ID information) including a remote identifier (ID) of the unmanned aircraft 15 flying according to the flight plan. The remote ID information includes an identifier, position information, and time information (also referred to as a time stamp) of the unmanned aircraft 15.

The flight management device 11 stores the flight plan information and the remote ID information in association with each other. The flight plan information and the remote ID information associated with each other are also referred to as shared information. The shared information for each flight plan of the unmanned aircraft 15 is shared between the flight management device 11, the operation device 12 that remotely operates the unmanned aircraft 15, and the unmanned aircraft 15 to be operated. The shared information for each unmanned aircraft 15 may be shared between different flight management devices 11.

The operation device 12 remotely operates the unmanned aircraft 15 to be operated included in the same flight unit 10. The operation device 12 is a ground station including a module for the operator who manages the unmanned aircraft 15 to pilot the unmanned aircraft 15. The operation device 12 is also referred to as a ground control station (GCS). The operation device 12 is communicably connected to the flight management device 11 and the unmanned aircraft 15. The operation device 12 communicates with the flight management device 11 and the unmanned aircraft 15. The operation device 12 is wirelessly connected to the unmanned aircraft 15. For example, the operation device 12 is connected to the unmanned aircraft 15 via wireless communication such as

WiFi (registered trademark) or Bluetooth (registered trademark). For example, the operation device 12 may be connected to the unmanned aircraft 15 via satellite communication. For example, the operation device 12 is connected to the unmanned aircraft 15 via a relay described below. The operation device 12 may be directly connected to the unmanned aircraft 15 via wireless communication. The connection between the operation device 12 and the unmanned aircraft 15 is not particularly limited.

Flight plan information including a flight plan is input to the operation device 12 via an input device (not illustrated). The flight plan information is assigned to the unmanned aircraft 15 that can be operated by the operation device 12. The operation device 12 associates the input flight plan information with the remote ID information of the unmanned aerial vehicle assigned to the flight plan information to generate shared information. The operation device 12 records the generated shared information. The operation device 12 also transmits the generated shared information to the flight management device 11. At the stage of registering the flight plan information in the flight management device 11, the shared information may include the remote ID of the unmanned aircraft 15. Further, the operation device 12 transmits the input flight plan information to the unmanned aircraft 15 assigned to the flight plan information. In this manner, the shared information for each flight plan of the unmanned aircraft 15 is shared between the flight management device 11, the operation device 12 for remotely operating the unmanned aircraft 15, and the unmanned aircraft 15 to be operated.

The operation device 12 remotely operates the unmanned aircraft 15 associated with the flight plan information according to the flight plan included in the flight plan information. When the scheduled departure time included in the flight plan comes, the operation device 12 activates the unmanned aircraft 15 to which the flight plan is assigned. The operation device 12 may activate the unmanned aircraft 15 before the scheduled departure time in such a way that the unmanned aircraft 15 can start flying at the scheduled departure time.

The operation device 12 receives the transmission information including the remote ID information from the activated unmanned aircraft 15. The operation device 12 updates the shared information in accordance with the received remote ID information. The operation device 12 transmits the updated shared information to the flight management device 11. When there is no change in the flight plan, the operation device 12 may transmit only the updated remote ID information to the flight management device 11. When the flight plan is changed, the operation device 12 transmits shared information including the changed flight plan and the updated remote ID information to the flight management device 11. The operation device 12 may transmit the flight plan information and the remote ID information constituting the shared information at different timings.

The operation device 12 transmits an operation signal related to the remote ID information and the flight plan of the unmanned aircraft 15 to the unmanned aircraft 15. Alternatively, the operation device 12 may transmit the operation signal to the unmanned aircraft 15 using inter-aircraft communication with the unmanned aircraft 15 separately from the remote ID information. In this case, the operation device 12 manages the flight of the unmanned aircraft 15 in cooperation with the flight management device 11 while referring to the position information of the unmanned aircraft 15 and the position information of the remote ID. The flight management device 11 manages the flight of the unmanned aircraft 15 using the position information of the unmanned aircraft 15 and the flight plan information. The operation device 12 remotely operates the unmanned aircraft 15 from the departure place to the destination place according to the position information and the flight plan of the unmanned aircraft 15. In a case where the distance between the departure place and the destination place is long, the operation device 12 remotely operates the unmanned aircraft 15 via the relay.

The unmanned aircraft 15 receives flight plan information from the operation device 12. The unmanned aircraft 15 stores shared information in which the remote ID information of the unmanned aircraft is associated with the flight plan information. Upon receiving update information of the registered flight plan information from the operation device 12, the unmanned aircraft 15 updates the registered flight plan information with the update information.

The unmanned aircraft 15 flies from the departure place to the destination place included in the flight plan information in response to the operation signal of the operation device 12. The unmanned aircraft 15 is communicably connected to the operation device 12. The unmanned aircraft 15 communicates with the operation device 12. The unmanned aircraft 15 is wirelessly connected to the operation device 12. For example, the unmanned aircraft 15 is connected to the operation device 12 via wireless communication such as WiFi (registered trademark) or Bluetooth (registered trademark). For example, the unmanned aircraft 15 is connected to the operation device 12 via a relay described below. The unmanned aircraft 15 may be directly connected to the operation device 12 via wireless communication. The connection between the operation device 12 and the unmanned aircraft 15 is not particularly limited.

When the scheduled departure time included in the flight plan comes, the unmanned aircraft 15 is activated according to the activation control of the operation device 12. The unmanned aircraft 15 may be activated before the scheduled departure time in such a way that it can start flying at the scheduled departure time. When activated, the unmanned aircraft 15 generates the remote ID information according to the position information and the time information at the time. The unmanned aircraft 15 transmits transmission information including remote ID information at a predetermined timing. The unmanned aircraft 15 transmits transmission information at a cycle of one or more times per second. The unmanned aircraft 15 updates the shared information according to the generated remote ID information. The transmission information transmitted from the unmanned aircraft 15 is received by the operation device 12.

The unmanned aircraft 15 receives an operation signal related to the remote ID information and the flight plan from the operation device 12. The unmanned aircraft 15 is remotely operated from the departure place to the destination place by the operation device 12 according to the remote ID information and the flight plan of the unmanned aircraft 15. In a case where the distance between the departure place and the destination place is large, the unmanned aircraft 15 is remotely operated by the operation device 12 via a relay. During flight, the unmanned aircraft 15 transmits transmission information including remote ID information at a predetermined timing. The transmission information transmitted from the unmanned aircraft 15 is received by the operation device 12.

For example, the unmanned aircraft 15 may transmit sensor data measured by a sensor (not illustrated) mounted on the unmanned aircraft with the sensor data being included in the transmission information. For example, the sensor data included in the transmission information transmitted from the unmanned aircraft 15 is used for determining the state of the unmanned aircraft 15 and the situation around the unmanned aircraft 15. For example, when the unmanned aircraft 15 is equipped with a radio wave interferometer, it is possible to detect the power transmission line on the flight route. The flight plan may be changed depending on the state of the unmanned aircraft 15 and the situation around the unmanned aircraft 15. The change in the flight plan will be described later.

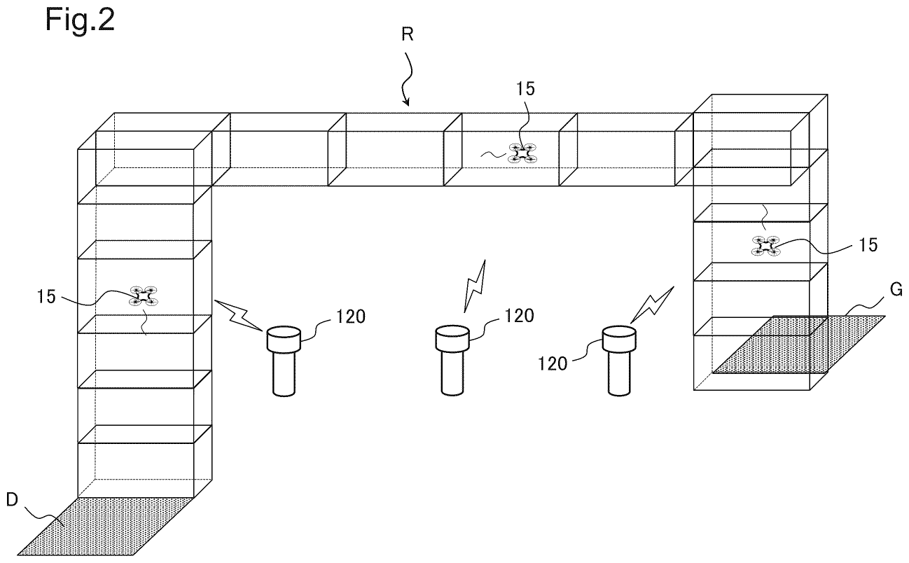

FIG. 2 is a conceptual diagram for describing an example of the flight of the unmanned aircraft 15. The unmanned aircraft 15 flies along the flight route R from the departure place D toward the destination place G. In the example of FIG. 2, an operation signal from the operation device 12 is transmitted from a relay 120 disposed near the departure place D, the flight route R, and the destination place G toward the unmanned aircraft 15. Communication means between the operation device 12 and the relay 120 is not particularly limited. For example, the operation device 12 may be disposed at any one of the departure place D, the flight route R, and the destination place G. The operation device 12 may transmit an operation signal to the unmanned aircraft 15 without via the relay 120.

Next, configurations of the flight management device 11, the operation device 12, and the unmanned aircraft 15 constituting the flight management system I will be individually described.

### [Flight Management Device]

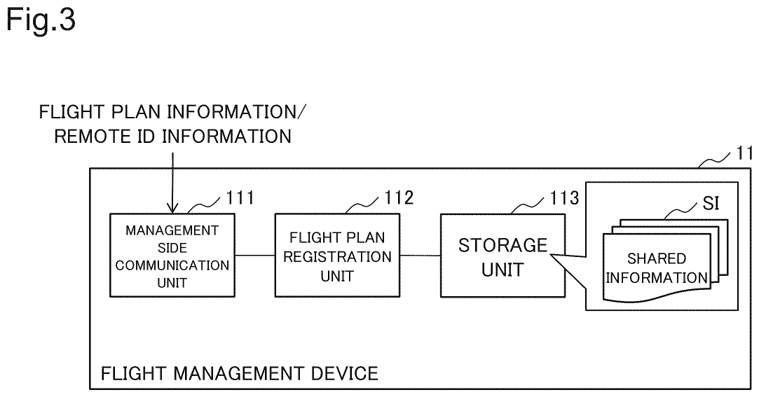

FIG. 3 is a block diagram illustrating an example of a configuration of the flight management device 11. The flight management device 11 includes a management side communication unit 111, a flight plan registration unit 112, and a storage unit 113. For example, the flight management device 11 is constructed in a server or a cloud (not illustrated).

The management side communication unit 111 receives the flight plan information and the remote ID information transmitted from the operation device 12. The flight plan information may be input to the management side communication unit 111 via an input device (not illustrated). For example, the management side communication unit 111 receives shared information SI including the flight plan information and the remote ID information. For example, the management side communication unit 111 individually receives the flight plan information and the remote ID information. The management side communication unit 111 communicates with the operation device 12 according to the same communication standard. For example, the management side communication unit 111 is wirelessly connected to the operation device 12. For example, the management side communication unit 111 is connected to the operation device 12 via a high-speed communication line such as LTE, fourth generation mobile communication, or fifth generation mobile communication.

The flight plan registration unit 112 stores the received flight plan information and remote ID information in the storage unit 113. The flight plan registration unit 112 stores the shared information SI including the flight plan information and the remote ID information in the storage unit 113. In a case of the new shared information SI, the flight plan registration unit 112 registers the shared information SI in the storage unit 113. In a case of the registered shared information SI, the flight plan registration unit 112 updates the shared information SI registered in the storage unit 113. For example, when individually acquiring the flight plan information, the flight plan registration unit 112 updates the flight plan information included in the shared information SI related to the flight plan information. Upon individually acquiring the remote ID information, the flight plan registration unit 112 updates the remote ID information included in the shared information SI related to the remote ID information.

The storage unit 113 stores shared information SI in which flight plan information and remote ID information are associated with each other. In a case of the new shared information, the shared information SI is registered in the storage unit 113. In a case of the registered shared information, the shared information SI registered in the storage unit 113 is updated. The shared information SI stored in the storage unit 113 is shared between the operation device 12 and the unmanned aircraft 15.

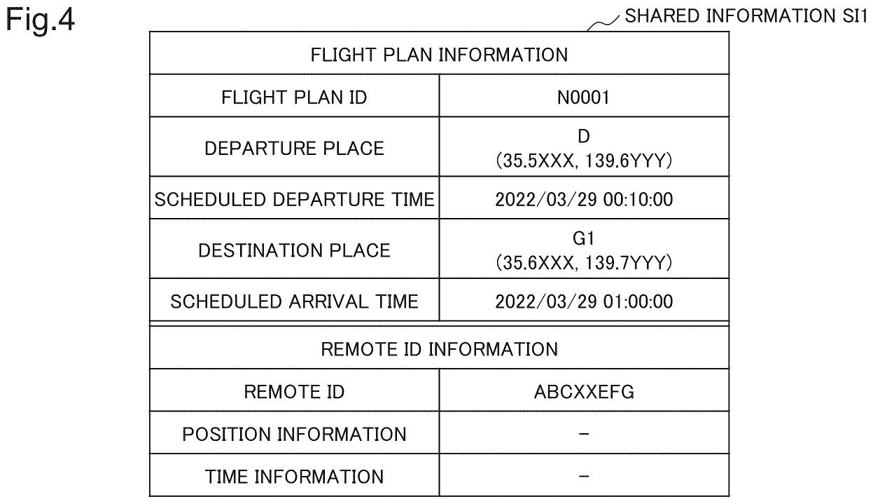

FIG. 4 is an example of shared information (shared information SI1) stored in the storage unit 113. The shared information SI1 includes flight plan information and remote ID information. The flight plan information includes an identifier (flight plan ID) for identifying the flight plan. The flight plan information includes position information of a departure place, a scheduled departure time, position information of a destination place, and a scheduled arrival time. The flight plan information may include information about a relay point (way point) in the flight route from the departure place to the destination place. For example, it is preferable that relay point information (way point information) including a relay point (way point) and a scheduled passing time of the relay point (way point) is included in the flight plan information. When the relay point information (way point information) is included in the flight plan information, it is easy to determine the flight route on which the unmanned aircraft 15 has flown. By accessing the flight plan ID, the position information of the departure place, the scheduled departure time, the position information of the destination place, and the scheduled arrival time included in the flight plan information are read. The remote ID information includes the remote ID of the unmanned aircraft 15 assigned to the flight plan. The remote ID information includes position information and time information of the unmanned aircraft 15 at the time when the unmanned aircraft 15 assigned to the flight plan transmits the remote ID information. In the example of FIG. 4, since the unmanned aircraft 15 has not yet executed the flight plan, the position information and the time information of the unmanned aircraft 15 are not indicated in the remote ID information. Even when the unmanned aircraft 15 is not yet executing the flight plan, the position information and the time information of the unmanned aircraft 15 at the time of registration of the shared information SI1 may be associated with the remote ID. For example, the shared information SI1 in FIG. 4 is displayed on a screen of a terminal device of an administrator who manages the flight of the unmanned aircraft 15 using the flight management device 11.

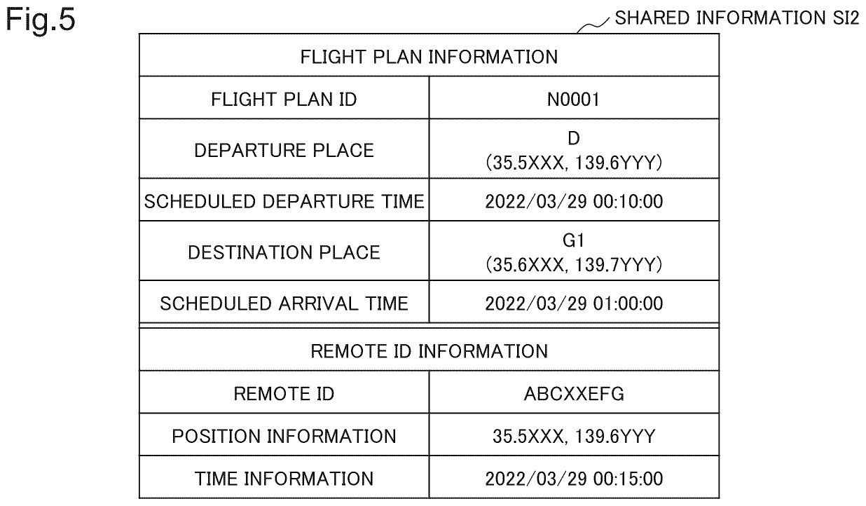

FIG. 5 illustrates another example (shared information SI2) of the shared information stored in the storage unit 113. The shared information SI2 is an example in which a flight plan by the unmanned aircraft 15 is being executed. The flight management device 11 receives the remote ID information transmitted from the unmanned aircraft 15 from the operation device 12. The position information and the time information of the remote ID information included in the shared information SI2 stored in the storage unit 113 are updated in response to the reception of the remote ID information transmitted from the unmanned aircraft 15. In this manner, the shared information SI stored in the flight management device 11 is updated to the same information as the shared information SI of the operation device 12 and the unmanned aircraft 15. For example, the shared information SI2 in FIG. 5 is displayed on a screen of a terminal device of an administrator who manages the flight of the unmanned aircraft 15 using the flight management device 11.

### [Operation Device]

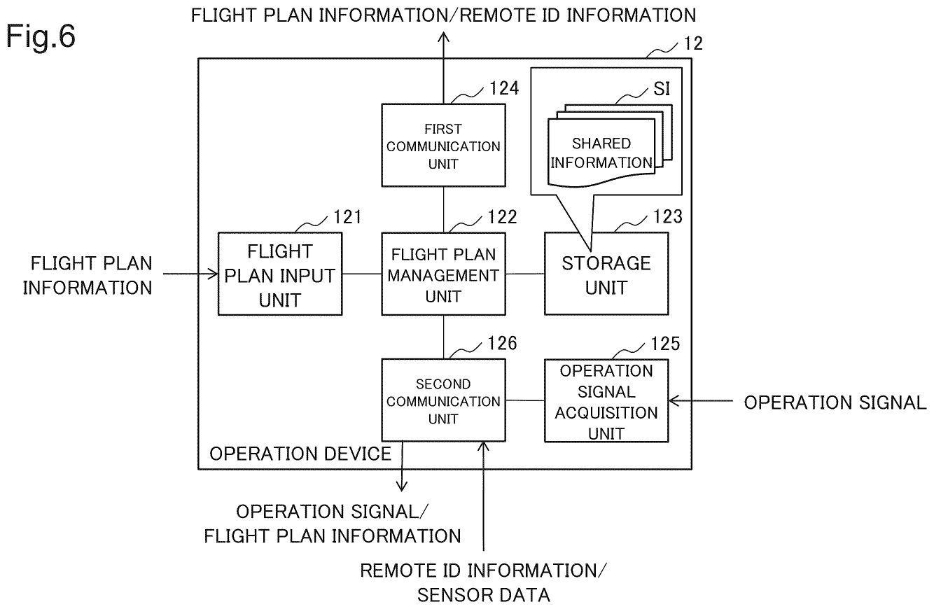

FIG. 6 is a block diagram illustrating an example of the configuration of the operation device 12. The operation device 12 includes a flight plan input unit 121, a flight plan management unit 122, a storage unit 123, a first communication unit 124, an operation signal acquisition unit 125, and a second communication unit 126. The configuration of FIG. 6 is an example in which the function of processing the remote ID information is built in the operation device 12. The operation device 12 may be configured in such a way that an external remote ID device that processes remote ID information is added.

The flight plan information is input to the flight plan input unit 121 by the administrator who manages the unmanned aircraft 15. The flight plan information includes a flight plan ID for each flight plan, position information of a departure place, and position information of a destination place. The flight plan information may include information related to designation of the unmanned aircraft 15 to execute the flight plan, a mission to be executed, designation of an operator to operate the unmanned aircraft 15, and the like. Not only the new flight plan but also information about a change in the registered flight plan is input to the flight plan input unit 121. For example, the flight plan input unit 121 is an input interface that acquires information input via a dedicated terminal for inputting flight plan information, a user interface installed in a general-purpose computer, or the like.

The flight plan management unit 122 acquires the flight plan input to the flight plan input unit 121. In response to the acquisition of the flight plan information, the flight plan management unit 122 assigns the unmanned aircraft 15 to the flight plan. The flight plan management unit 122 assigns the unmanned aircraft 15 that can stand by at the departure place at the scheduled departure time included in the flight plan information to the flight plan of the flight plan information. The flight plan management unit 122 generates the shared information SI by associating the acquired flight plan information with the remote ID information of the unmanned aircraft 15 assigned to the flight plan of the flight plan information. The flight plan management unit 122 stores the generated shared information in the storage unit 123. The flight plan management unit 122 outputs the generated shared information to the first communication unit 124 and the second communication unit 126. The shared information SI output to the first communication unit 124 is transmitted to the flight management device 11. The shared information SI output to the second communication unit 126 is transmitted toward the unmanned aircraft 15.

The flight plan management unit 122 acquires information about a change in the registered flight plan information. The flight plan management unit 122 acquires, from the flight plan input unit 121, information about a change in the flight plan information input by the administrator. The flight plan management unit 122 updates the registered shared information SI in accordance with the acquisition of the changed flight plan information. The flight plan management unit 122 outputs update information of the flight plan information to the first communication unit 124 and the second communication unit 126. The update information of the flight plan information output to the first communication unit 124 is transmitted to the flight management device 11. The update information of the flight plan information output to the second communication unit 126 is transmitted toward the unmanned aircraft 15.

The flight plan management unit 122 acquires the remote ID information transmitted from the unmanned aircraft 15 from the second communication unit 126. The flight plan management unit 122 acquires the remote ID information transmitted from the unmanned aircraft 15 from the second communication unit 126. The flight plan management unit 122 updates the registered shared information SI in response to the acquisition of the remote ID information. The flight plan management unit 122 outputs the acquired remote ID information to the first communication unit 124 and the second communication unit 126. The remote ID information output to the first communication unit 124 is transmitted to the flight management device 11. The remote ID information output to the second communication unit 126 is transmitted toward the unmanned aircraft 15.

The flight plan management unit 122 also acquires information (also referred to as instruction information) including an instruction transmitted from the flight management device 11 from the first communication unit 124. The flight plan management unit 122 updates the flight plan information according to the acquired instruction information. For example, in a case of weather in which the mission included in the flight plan is not allowed to be executed or in a case where an overall flight management problem occurs, instruction information requesting review of the flight plan is transmitted from the flight management device 11. The flight plan management unit 122 changes the flight plan information in accordance with instruction information from the flight management device 11. In a case where the change according to the instruction information cannot be made only by the flight plan management unit 122, the instruction information may be presented to the administrator of the operation device 12 or the operator of the unmanned aircraft 15. The administrator of the operation device 12 and the operator of the unmanned aircraft 15 can input a change in the flight plan information according to the instruction information.

The storage unit 123 stores shared information SI in which flight plan information and remote ID information are associated with each other. In a case of new shared information, the shared information SI is registered in the storage unit 123. In a case of the registered shared information, the shared information SI registered in the storage unit 123 is updated. The shared information SI stored in the storage unit 123 is shared between the flight management device 11 and the unmanned aircraft 15.

The first communication unit 124 transmits the new shared information SI to the flight management device 11. For example, the first communication unit 124 individually transmits the flight plan information and the remote ID information. The first communication unit 124 transmits update information of flight plan information included in the registered shared information SI to the flight management device 11. The first communication unit 124 transmits, to the flight management device 11, the remote ID information acquired from the unmanned aircraft 15 executing a mission according to the flight plan. The first communication unit 124 also acquires instruction information transmitted from the flight management device 11.

The first communication unit 124 communicates with the flight management device 11 using the same communication standard. For example, the first communication unit 124 is wirelessly connected to the flight management device 11. For example, the first communication unit 124 is connected to the flight management device 11 via a high-speed communication line such as LTE, fourth generation mobile communication, or fifth generation mobile communication.

The operation signal acquisition unit 125 acquires an operation signal for operating the unmanned aircraft 15 carrying out the flight plan. The operation signal acquisition unit 125 outputs the acquired operation signal to second communication unit 126. The operation signal is generated in response to an input operation of an operator of the unmanned aircraft 15. The operation signal is a signal related to an input operation for operating the unmanned aircraft 15 from the departure place toward the destination place according to the flight plan. The input operation includes information about a flight direction, a flight speed, a flight altitude, and the like of the unmanned aircraft 15. For example, the operation signal is generated via a dedicated controller for performing input operations. For example, the operation signal may be input via a user interface installed in a general-purpose computer or the like. The operation signal acquisition unit 125 is an input interface to which an operation signal is input.

The second communication unit 126 transmits new flight plan information to the unmanned aircraft 15. For example, the second communication unit 126 transmits update information of the flight plan information included in the registered shared information SI to the unmanned aircraft 15. The second communication unit 126 acquires the operation signal from the operation signal acquisition unit 125. The second communication unit 126 transmits the acquired operation signal to the unmanned aircraft 15.

The second communication unit 126 receives the remote ID information from the unmanned aircraft 15 executing a mission according to the flight plan. The second communication unit 126 outputs the received remote ID information to the flight plan management unit 122. The second communication unit 126 receives sensor data detected by the unmanned aircraft 15. For example, the second communication unit 126 receives sensor data such as an acceleration, an angular velocity, a velocity, an altitude, an atmospheric pressure, and temperature. For example, the second communication unit 126 receives image data and video data captured by a camera mounted on the unmanned aircraft 15. The type and application of the sensor data are not particularly limited.

The second communication unit 126 communicates with the unmanned aircraft 15 using the same communication standard. The second communication unit 126 is wirelessly connected to the unmanned aircraft 15. For example, the second communication unit 126 is connected to the unmanned aircraft 15 via wireless communication such as WiFi (registered trademark) or Bluetooth (registered trademark). For example, the second communication unit 126 is connected to the unmanned aircraft 15 via a relay 120. The second communication unit 126 may be directly connected to the unmanned aircraft 15 via wireless communication. The connection between the second communication unit 126 and the unmanned aircraft 15 is not particularly limited.

### [Unmanned Aircraft]

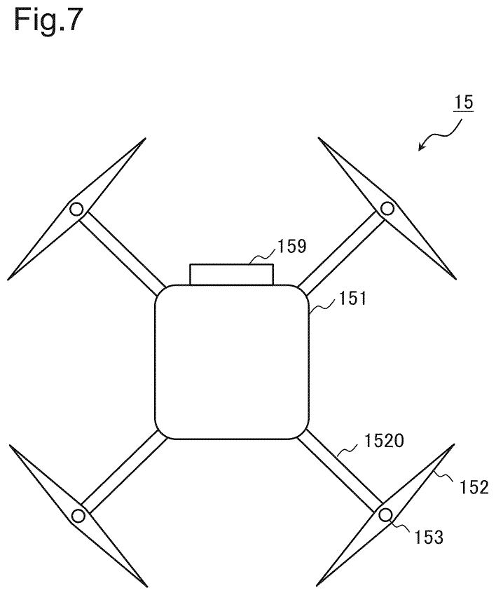

FIG. 7 is a conceptual diagram illustrating an example of a configuration of the unmanned aircraft 15. FIG. 7 is a plan view of the unmanned aircraft 15. A bottom view, a side view, a rear view, a slope view, and the like of the unmanned aircraft 15 are omitted. A propeller 152 and a motor 153 are attached to a main body 151 of the unmanned aircraft 15 by means of an arm 1520. A camera 159 for imaging the area in front of the unmanned aircraft is mounted on the unmanned aircraft 15. An attachment position and an imaging direction of the camera 159 are set in any manner. A remote ID device that transmits transmission information including a registration number, a manufacturing number, position information, time, and authentication information is mounted on the unmanned aircraft 15.

FIG. 7 illustrates, by way of example, a quadcopter including four propellers 152. The unmanned aircraft 15 may include a single propeller 152 or may be a multicopter including a plurality of propellers 152. Considering the posture stability in the air and the flight performance, the unmanned aircraft 15 is preferably a multicopter including a plurality of propellers 152. In a case where a plurality of propellers 152 is attached to the unmanned aircraft 15, the size of the propellers 152 may be different. The rotating surfaces of the plurality of propellers 152 may be different from each other.

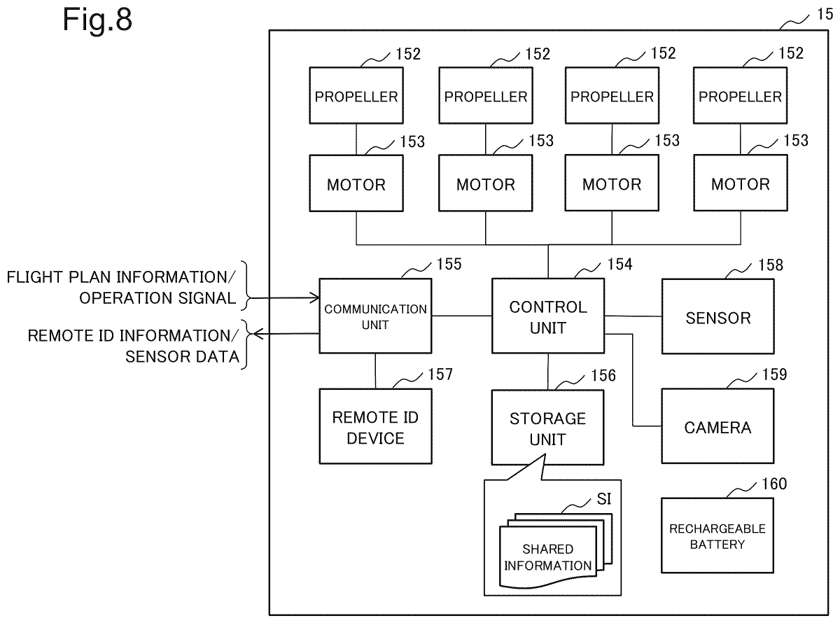

FIG. 8 is a block diagram for describing a function configuration of the unmanned aircraft 15. The unmanned aircraft 15 includes the main body 151, the propeller 152, the motor 153, a control unit 154, a communication unit 155, a storage unit 156, a remote ID device 157, the camera 159, and a rechargeable battery 160. The control unit 154, the communication unit 155, the storage unit 156, and the remote ID device 157 are stored inside the main body 151. Most of the camera 159 except for the lens is accommodated in the main body 151. FIG. 7 illustrates part of the lens of the camera 159.

The unmanned aircraft 15 has a function of executing a mission according to the flight plan. In a case where the unmanned aircraft 15 is used to carry a cargo, the unmanned aircraft has a cargo carrying function (not illustrated). For example, the unmanned aircraft 15 transports a cargo by storing the cargo inside the main body 151, hanging the cargo from the main body 151, or loading the cargo on the main body 151. In a case of hanging a cargo from the main body 151, the camera 159 may be attachable under the cargo in order to image the lower side of the unmanned aircraft 15. In a case where the unmanned aircraft 15 is used for inspecting and monitoring an infrastructure, the unmanned aircraft has a sensor or the like for inspecting and monitoring a facility to be inspected. The function implemented in the unmanned aircraft 15 is not particularly limited as long as a mission according to the flight plan is allowed to be executed.

The main body 151 is a housing that stores the control unit 154, the communication unit 155, the storage unit 156, the remote ID device 157, and the like. At least one propeller 152 for causing the unmanned aircraft 15 to fly is attached to the main body 151. For example, the main body 151 is provided with a space for accommodating a cargo therein, a mechanism for hanging a cargo, a place for placing a cargo thereon, and the like depending on the application. The shape and material of the main body 151 are not particularly limited.

The propeller 152 is a mechanism that causes the unmanned aircraft 15 to fly. The propeller 152 is also referred to as a rotor or a rotary wing. For example, propeller 152 is made of lightweight plastic or metal having high strength. The propeller 152 is attached to the motor 153 fixed to the main body 151 by the arm 1520. The propeller 152 is a blade for floating the main body 151 by rotating. The size and mounting position of the propeller 152 in FIG. 7 are conceptual and are not sufficiently designed for flying the unmanned aircraft 15. In the example of FIG. 7, four propellers 152 are installed in the main body 151 of the unmanned aircraft 15. The rotational speeds of the plurality of propellers 152 is controlled independently of each other.

The motor 153 is installed in each of the plurality of propellers 152. The motor 153 is a drive mechanism for rotating the propeller 152. The motor 153 rotates the propeller 152 under the control of the control unit 154. The motor 153 is achieved by a precise small motor which has little vibration and can operate for a long time at a high rotational speed.

The control unit 154 is a control device that controls the unmanned aircraft 15. For example, the control unit 154 is achieved by a control device such as a microcomputer or a microcontroller. The control unit 154 controls the rotation of the propeller 152 according to the operation signal. The control unit 154 controls the rotational speed of each propeller 152 by driving and controlling the motor 153 of each propeller 152. For example, the control unit 154 may control the unmanned aircraft 15 in such a way that the position of the unmanned aircraft 15 changes according to a preset flight route. For example, the control unit 154 may be configured to navigate the unmanned aircraft 15 by controlling the rotation of the propeller 152 according to a preset flight condition. For example, the flight condition is a condition in which the operation performed by the unmanned aircraft 15 is summarized in a table form. The flight route and the flight condition may be stored in the storage unit 156.

The control unit 154 performs imaging control of the camera 159. The control unit 154 causes the camera 159 to capture an image at a predetermined timing. The control unit 154 acquires an image captured by the camera 159. The control unit 154 may acquire an image captured by the camera 159 without performing imaging control of the camera 159. For example, the control unit 154 may be configured to control the flight of the unmanned aircraft 15 by controlling the rotational speed of each propeller 152 according to the features included in the image captured by the camera 159. In a case of providing an image to the flight management device 11, the control unit 154 outputs the acquired image to the communication unit 155.

The communication unit 155 receives flight plan information and update information of the flight plan information transmitted from the operation device 12. The communication unit 155 receives an operation signal transmitted from the operation device 12. The communication unit 155 outputs the received flight plan information, update information of the flight plan information, and an operation signal to the control unit 154.

Communication unit 155 transmits transmission information including remote ID information generated by remote ID device 157. The remote ID information includes registration information, a manufacturing number, position information, time information, authentication information (also referred to as identification information) and the like of the unmanned aircraft 15. The registration information, the manufacturing number, the authentication information and the like of the unmanned aircraft 15 are fixed information (also referred to as fixed information). The position information and the time information are information (also referred to as variation information) that is updated as needed. The unmanned aircraft 15 continues to transmit remote ID information for a period of time during which it is performing a mission according to the flight plan. For example, the unmanned aircraft 15 continues to transmit the remote ID information at a transmission cycle of one or more times per second. The communication unit 155 may transmit sensor data measured by the sensor 158 and image data captured by the camera 159. The transmission timing of the sensor data and the image data is not particularly limited. For example, the communication unit 155 is connected to the operation device 12 via wireless communication such as WiFi (registered trademark) or Bluetooth (registered trademark). For example, the communication unit 155 is connected to the operation device 12 via the relay 120. The communication unit 155 may be directly connected to the operation device 12 via wireless communication. The connection between the communication unit 155 and the operation device 12 is not particularly limited.

The storage unit 156 stores shared information SI in which flight plan information and remote ID information are associated with each other. In response to the acquisition of the new flight plan information, the shared information SI in which the remote ID is associated with the flight plan information is registered in the storage unit 156. The shared information SI registered in the storage unit 156 is updated in response to the acquisition of the update information of the flight plan information included in the registered shared information. The shared information SI stored in the storage unit 156 is shared between the flight management device 11 and the operation device 12.

The remote ID device 157 is a device that generates unique remote ID information for each unmanned aircraft 15. The remote ID device 157 may be a general-purpose device that can be mounted on the unmanned aircraft 15 or may be a device mounted on the unmanned aircraft 15. The remote ID information includes fixed information and variation information. The remote ID device 157 generates transmission information including fixed information and variation information at a predetermined cycle. For example, the remote ID device 157 generates the remote ID information at a predetermined cycle of one or more times per second. The fixed information includes registration information, a manufacturing number, authentication information and the like of the unmanned aircraft 15. The fixed information may be stored in a storage area (not illustrated). The variation information includes position information and time information. For example, the remote ID device 157 generates position information using positioning data collected by a positioning system such as a global positioning system (GPS). The remote ID device 157 may acquire the position information of the position measurement device from the position measurement device (not illustrated) installed around the flight route. In a case where a function capable of identifying a position is implemented in the sensor 158, the remote ID device 157 may generate the position information by using data collected by the sensor 158. The remote ID device 157 outputs the generated remote ID information to the communication unit 155.

The sensor 158 is a sensor that detects the state of the unmanned aircraft 15 and the state around the unmanned aircraft 15. For example, the sensor 158 includes a geomagnetic sensor, an acceleration sensor, a speed sensor, an altitude sensor, a distance measurement sensor, and the like. The sensor 158 may be equipped with a GPS function. The sensor 158 outputs the detected sensor data to the control unit 154. The type and use of the sensor data detected by the sensor 158 are not particularly limited.

The camera 159 is disposed to image the surroundings of the unmanned aircraft 15. In a case of FIG. 7, the camera 159 images the area in front of the unmanned aircraft 15. The camera 159 may be mounted at a position where the area on the sides of, the area below, and the area above the unmanned aircraft 15 can be imaged. A plurality of cameras 159 may be mounted on the unmanned aircraft 15 in order to image the area on the sides of, the area below, and the area above the unmanned aircraft 15. For example, the camera 159 may be disposed to be able to capture images in multiple directions by changing the aerial posture of the unmanned aircraft 15. The camera 159 captures an image under the control of the control unit 154. The camera 159 may capture an image at a predetermined timing without being controlled by the control unit 154. The camera 159 outputs captured image data (also referred to as an image) to the communication unit 155. An imaging lens is incorporated in the camera 159. The lens is preferably a zoom lens capable of changing a focal length. The lens may be provided with a protection member such as a protection film or a protection glass. The camera 159 is preferably equipped with an autofocus function of automatically focusing. The camera 159 is preferably equipped with a function applied to a general digital camera, such as a function of preventing camera shake. A specific structure of the camera 159 will not be described.

The rechargeable battery 160 is a general secondary battery having a charging function. The rechargeable battery 160 is a power source of the unmanned aircraft 15. The rechargeable battery 160 is not particularly limited as long as the unmanned aircraft 15 can fly from the departure place to the destination place along the flight route. For example, the rechargeable battery 160 preferably has a function of controlling charging of the rechargeable battery 160 and a function of monitoring a charging amount of the rechargeable battery 160.

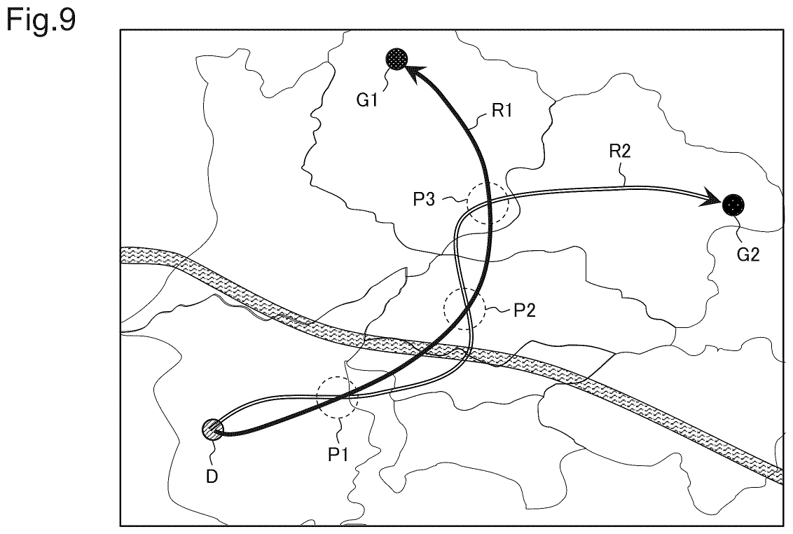

FIG. 9 is a conceptual diagram for describing an example of a flight route of the unmanned aircraft 15 that executes a mission according to a flight plan. FIG. 9 illustrates two flight routes (flight route R1, flight route R2). The flight route R1 is a route from the departure place D to the destination place G1. The flight route R2 is a route from the departure place D to the destination place G2. The flight route R1 and the flight route R2 have different destination places, but have points (point P1, point P2, point P3) where the flight route R1 and the flight route R2 intersect with each other on the way. In a case where the unmanned aircraft 15 is flying on the flight route R1 or the flight route R2, it is not possible to determine which one of the flight route R1 and the flight route R2 the unmanned aircraft is flying from the position information included in the remote ID information transmitted at the point P1, the point P2, and the point P3. In the present example embodiment, a flight plan of a mission being executed is shared between the flight management device 11, the operation device 12, and the unmanned aircraft 15. Therefore, according to the present example embodiment, even when the remote ID information is transmitted from a point where the flight route R1 and the flight route R2 intersect, such as the point P1, the point P2, or the point P3, it is possible to determine which flight route the flight management device 11 is flying.

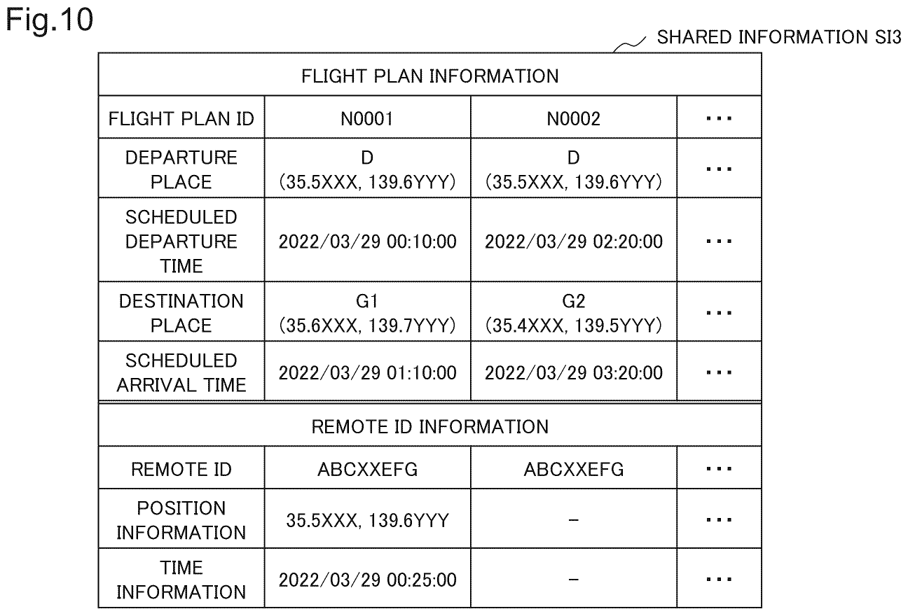

FIG. 10 illustrates an example of shared information (shared information SI3) regarding the unmanned aircraft 15 in flight according to the mission according to the flight plan. The shared information SI3 of FIG. 10 includes a plurality of pieces of flight plan information for the same unmanned aircraft 15. The unmanned aircraft 15 whose remote ID is “ABCXXEFG” is executing a mission according to the flight plan included in the flight plan information of the flight plan ID_N0001. The unmanned aircraft 15 transmits the remote ID information associated with the flight plan information of the flight plan ID_N0001 to the operation device 12. The flight management device 11, the operation device 12, and the unmanned aircraft 15 update the shared information SI3 including the flight plan information of the flight plan ID_N0001 in execution as needed. The remote ID information associated with the flight plan information of the flight plan ID_N0002 is not updated until a mission according to the flight plan is performed. By using the shared information SI3 of FIG. 10, it is possible to manage a plurality of flight plans planned for the same unmanned aircraft 15. For example, the shared information SI3 in FIG. 10 is displayed on a screen of a terminal device of an administrator who manages the flight of the unmanned aircraft 15 using the flight management device 11.

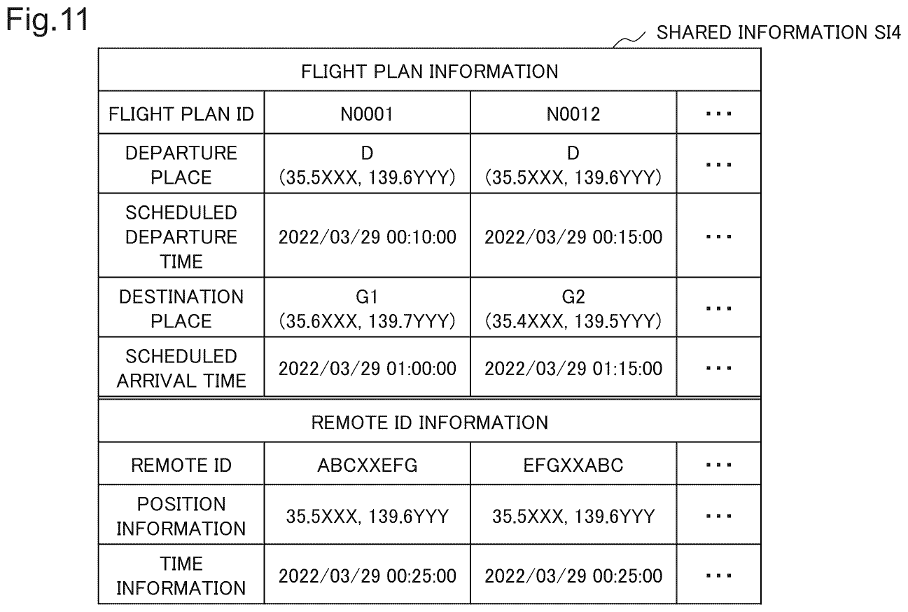

FIG. 11 is another example (shared information SI4) of the shared information about the unmanned aircraft 15 in flight according to the mission according to the flight plan. The shared information SI4 of FIG. 11 includes flight plan information for different unmanned aircrafts 15. The unmanned aircraft 15 whose remote ID is “ABCXXEFG” is executing a mission according to the flight plan included in the flight plan information of the flight plan ID_N0001. The unmanned aircraft 15 whose remote ID is “ABCXXEFG” transmits the remote ID information associated with the flight plan information of the flight plan ID_N0001 to the operation device 12. The flight management device 11, the operation device 12, and the unmanned aircraft 15 whose remote ID is

“ABCXXEFG” update the shared information SI4 including the flight plan information of the flight plan ID_N0001 in execution as needed. On the another hand, the unmanned aircraft 15 whose remote ID is “EFGXXABC” is executing a mission according to the flight plan included in the flight plan information of the flight plan ID_N0012. The unmanned aircraft 15 whose remote ID is “EFGXXABC” transmits the remote ID information associated with the flight plan information of the flight plan ID_N0012 to the operation device 12. The flight management device 11, the operation device 12, and the unmanned aircraft 15 whose remote ID is

“EFGXXABC” update the shared information SI4 including the flight plan information of the flight plan ID_N0012 being executed as needed. By using the shared information SI4 of FIG. 11, flight plans individually planned for the plurality of unmanned aircrafts 15 can be managed. For example, the shared information SIS in FIG. 11 is displayed on a screen of a terminal device of an administrator who manages the flight of the unmanned aircraft 15 using the flight management device 11.

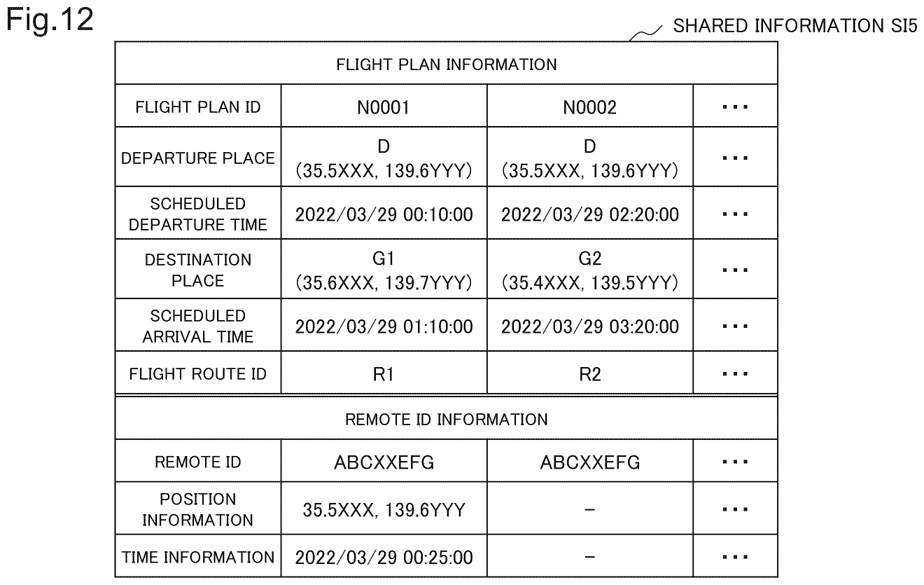

FIG. 12 is still another example (shared information SI5) of the shared information about the unmanned aircraft 15 in flight according to the mission according to the flight plan. The shared information SIS of FIG. 12 includes a plurality of pieces of flight plan information for the same unmanned aircraft 15. The shared information SIS includes an identifier (flight route ID) regarding a flight route in a stage of performing a mission according to the flight plan. The unmanned aircraft 15 whose remote ID is “ABCXXEFG” is executing a mission while flying along the flight route R1 according to the flight plan included in the flight plan information of the flight plan ID_N0001. The unmanned aircraft 15 transmits the remote ID information associated with the flight plan information of the flight plan ID_N0001 to the operation device 12. The flight management device 11, the operation device 12, and the unmanned aircraft 15 update the shared information SI5 including the flight plan information of the flight plan ID_N0001 in execution as needed. The remote ID information associated with the flight plan information of the flight plan ID_N0002 is not updated until a mission according to the flight plan is performed. By using the shared information SIS of FIG. 12, a plurality of flight plans planned for the same unmanned aircraft 15 can be managed according to the flight route. For example, the shared information SIS in FIG. 12 is displayed on a screen of a terminal device of an administrator who manages the flight of the unmanned aircraft 15 using the flight management device 11.

### (Operation)

Next, an operation of the flight management system 1 according to the present example embodiment will be described with reference to the drawings. Hereinafter, operations of the flight management device 11, the operation device 12, and the unmanned aircraft 15 constituting the flight management system I will be individually described.

### [Flight Management Device]

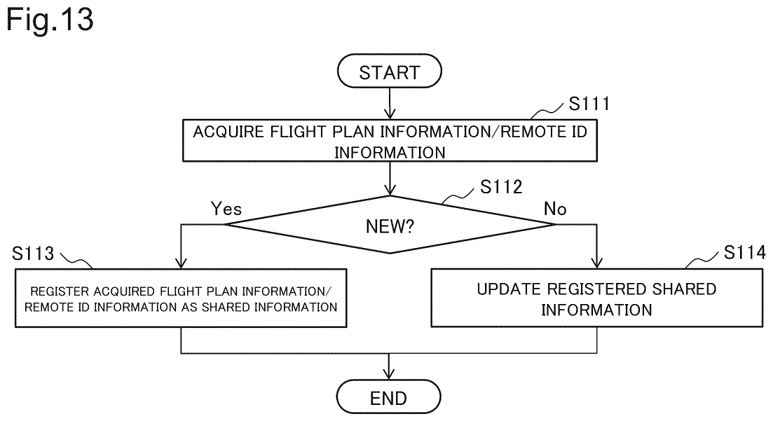

FIG. 13 is a flowchart for describing an example of the operation of the flight management device 11. In the description along the flowchart of FIG. 13, the flight management device 11 will be described as an operation subject.

In FIG. 13, first, the flight management device 11 acquires flight plan information/remote ID information (step S111). Regarding the new flight plan, the flight management device 11 acquires a data set of flight plan information and remote ID information. Regarding the registered flight plan, the flight management device 11 acquires updated flight plan information or remote ID information.

In a case of a new flight plan (Yes in step S112), the flight management device 11 registers the acquired flight plan information/remote ID information as new shared information (step S113).

In a case where the flight plan is a registered flight plan (No in step S112), the flight management device 11 updates the registered shared information using the acquired update information (step S114).

### [Operation Device]

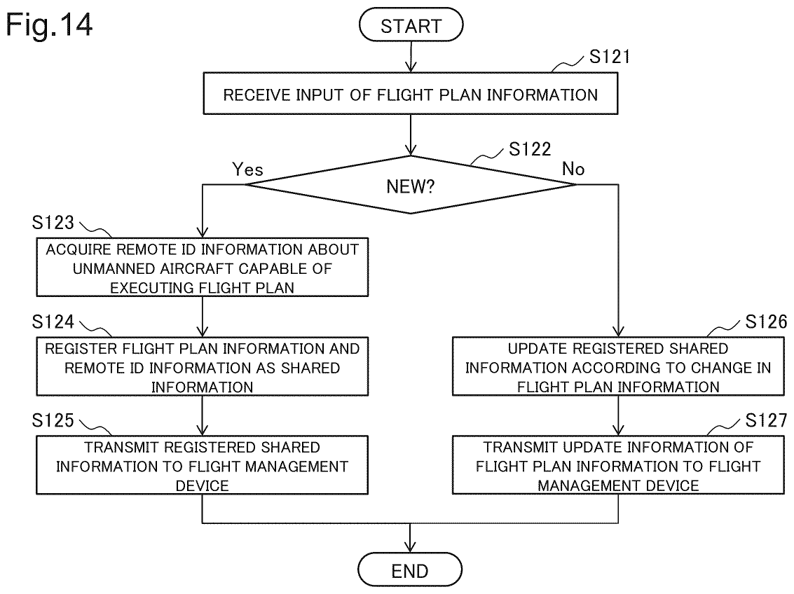

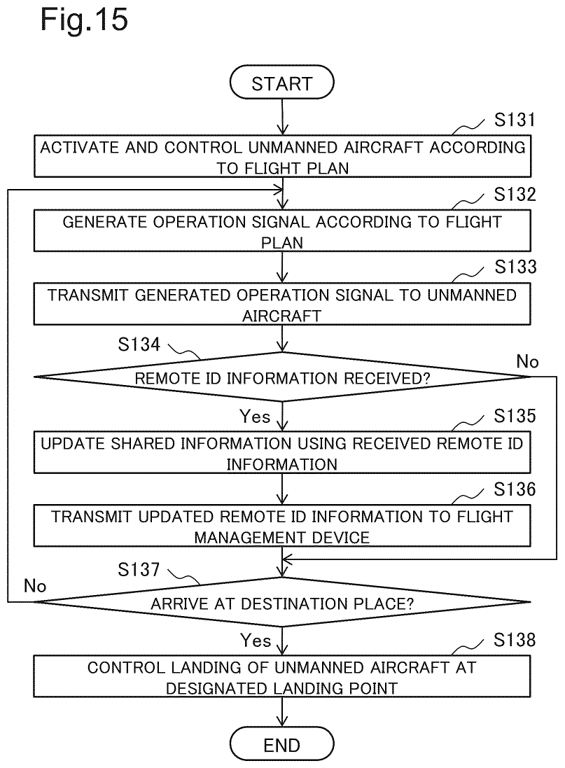

FIGS. 14 to 15 are flowcharts for describing an example of the operation of the operation device 12. FIG. 14 relates to sharing of flight plan information input to the operation device 12. FIG. 15 relates to controlling, according to a flight plan, the unmanned aircraft 15 to which the flight plan is assigned. In the description along the flowcharts of FIGS. 14 to 15, the operation device 12 will be described as an operation subject.

In FIG. 14, first, the operation device 12 receives an input of flight plan information (Yes in step S121).

In a case of a new flight plan (Yes in step S122), the operation device 12 acquires remote ID information of the unmanned aircraft 15 capable of executing the flight plan (step S123). The flight management device 11 registers the acquired flight plan information and remote ID information as new shared information (step S124). The operation device 12 transmits the registered shared information (flight plan information/remote ID information) to the flight management device 11 (step S125).

In a case of the registered flight plan (No in step S122), the flight management device 11 updates the registered shared information in accordance with the change in the acquired flight plan information (step S126). The operation device 12 transmits update information of the changed flight plan information to the flight management device 11 (step S127).

In FIG. 15, first, the operation device 12 activates and controls the unmanned aircraft 15 to which the flight plan is assigned according to the flight plan (step S131).

Next, the operation device 12 generates an operation signal according to the flight plan (step S132). The operation signal is input by the operator of the unmanned aircraft 15. In a case where automatic flight of the unmanned aircraft 15 is possible, the operation signal may be automatically generated according to the flight plan.

Next, the operation device 12 transmits the generated operation signal to the unmanned aircraft 15 (step S133). The unmanned aircraft 15 performs a mission according to the flight plan by operating in response to the operation signal.

When the remote ID information is received from the unmanned aircraft 15 executing the mission according to the flight plan (Yes in step S134), the operation device 12 updates the shared information using the received remote ID information (step S135). The operation device 12 transmits the updated remote ID information to the flight management device 11 (step S136).

After step S136 or in a case of No in step S134, in a case where the operation device 12 has not arrived at the destination place (No in step S137), the process returns to step S132. On the another hand, when the unmanned aircraft 15 arrives at the destination place (Yes in step S137), the operation device 12 controls landing of the unmanned aircraft 15 at the designated landing point (step S138).

### [Unmanned Aircraft]

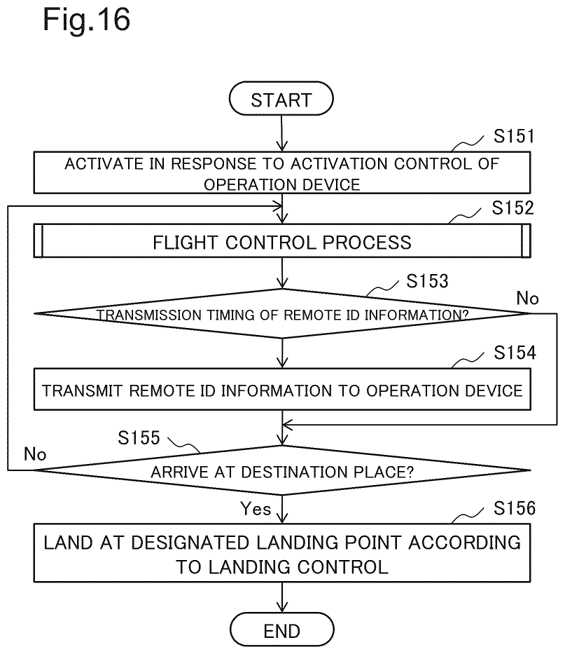

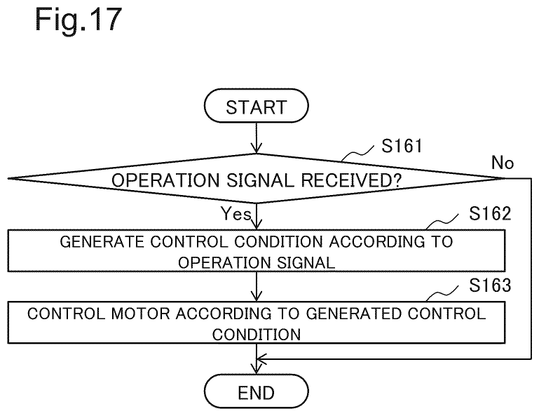

FIGS. 16 to 17 are flowcharts for describing an example of the operation of the unmanned aircraft 15. FIG. 16 relates to the execution of a mission according to a flight plan. FIG. 17 relates to a flight control process included in the operation of FIG. 16. In the description along the flowcharts of FIGS. 16 to 17, the unmanned aircraft 15 will be described as the operation subject.

In FIG. 16, first, the unmanned aircraft 15 is activated according to the activation control of the operation device 12 (step S151).

Next, the unmanned aircraft 15 executes a flight control process (step S152). Details of the flight control process will be described later.

In a case of the transmission timing of the remote ID information (Yes in step S153), the unmanned aircraft 15 transmits the remote ID information including the position information and the time information at the time to the operation device 12 (step S154).

After step S154 or in a case of No in step S153, in a case where the unmanned aircraft 15 has not arrived at the destination place (No in step S155), the process returns to step S152. On the another hand, when arriving at the destination place (Yes in step S155), the unmanned aircraft 15 lands at the designated landing point in accordance with the landing control of the operation device 12 (step S156).

In FIG. 17, first, upon receiving the operation signal (Yes in step S161), the unmanned aircraft 15 generates a control condition for the motor 153 in accordance with the operation signal (step S162). In a case where the operation signal is not received (No in step S161), the process proceeds to step S153 in FIG. 16.

After step S162, the unmanned aircraft 15 controls the motor 153 according to the generated control conditions (step S163). The unmanned aircraft 15 flies according to the rotation state of the propeller 152 driven according to the control of the motor 153. After step S163, the process proceeds to step S153 in FIG. 16.

As described above, the flight management system of the present example embodiment includes the flight management device, the operation device, and the unmanned aircraft. The flight management system manages flight of an unmanned aircraft that flies according to a flight plan. The flight plan information includes identification information, a departure place, a scheduled departure time, a destination place, and a scheduled arrival time of the flight plan.

The unmanned aircraft holds shared information in which transmission information including identification information, position information, and time information of the unmanned aircraft is associated with flight plan information including a flight plan. The unmanned aircraft flies according to the flight plan while transmitting transmission information at a predetermined timing.

In response to the input of the flight plan information, the operation device assigns the flight plan included in the flight plan information to the unmanned aircraft to be managed. The operation device generates shared information in which transmission information of the unmanned aircraft to which the flight plan is assigned is associated with the flight plan information. The operation device transmits the generated shared information to the flight management device, and the operation device transmits flight plan information to the unmanned aircraft to which the flight plan is assigned. The operation device activates the unmanned aircraft in accordance with the flight plan. The operation device transmits an operation signal for operating the unmanned aircraft to the activated unmanned aircraft.

The flight management device shares shared information with the unmanned aircraft to be managed. The flight management device acquires transmission information transmitted from the unmanned aircraft that flies according to the flight plan and updates the shared information.

The flight management system of the present example embodiment shares shared information including transmission information of an unmanned aircraft and flight plan information between the unmanned aircraft that flies according to a flight plan and a flight management device that manages the unmanned aircraft. Therefore, according to the present example embodiment, by updating the shared information as needed according to the transmission information transmitted from the unmanned aircraft, the flight management device can accurately manage the flight situation of the unmanned aircraft.

The position information included in the remote ID information (transmission information) is position information at the time when the remote ID information is transmitted. Therefore, it is not possible to identify that the position information included in the remote ID transmitted from a point where different flight routes overlap is transmitted during flight in which the aircraft flies on which flight route. According to the method of the present example embodiment, the shared information in which the remote ID and the flight plan information are associated with each other is shared between the flight management device and the unmanned aircraft, whereby the flight of the unmanned aircraft is allowed to be accurately managed using the remote ID information.

In an aspect of the present example embodiment, the flight plan information includes identification information of a flight route from a departure place to a destination place. The flight management device manages flight of the unmanned aircraft assigned to the flight plan according to the identification information of the flight route. According to the present aspect, it is possible to more accurately manage the flight situation of the unmanned aerial vehicle by managing flight of the unmanned aircraft in accordance with not only the position information but also the identification information of the flight route.

In an aspect of the present example embodiment, the operation device generates update information of the flight plan in response to a change in the flight plan. The operation device transmits generated update information of the flight plan to the flight management device and the unmanned aircraft. According to the present aspect, it is possible to more accurately manage the flight situation of the unmanned aerial vehicle by updating the shared information between the flight management device and the unmanned aircraft in accordance with the change in the flight plan.

In an aspect of the present example embodiment, the operation device acquires transmission information transmitted from the unmanned aircraft that is flying according to the flight plan. The operation device updates the shared information using the acquired transmission information. The operation device transmits the acquired transmission information to the flight management device. According to the present aspect, it is possible to more accurately manage the flight situation of the unmanned aerial vehicle by updating the shared information between the flight management device and the unmanned aircraft according to the transmission information of the unmanned aircraft.

### Second Example Embodiment

Next, a flight management system 2 according to a second example embodiment will be described with reference to the drawings. In the flight management system of the present example embodiment, the operation device controls the positional relationship of the plurality of unmanned aircrafts according to the positional relationship of the plurality of unmanned aircrafts that is executing the mission according to the flight plan.

### (Configuration)

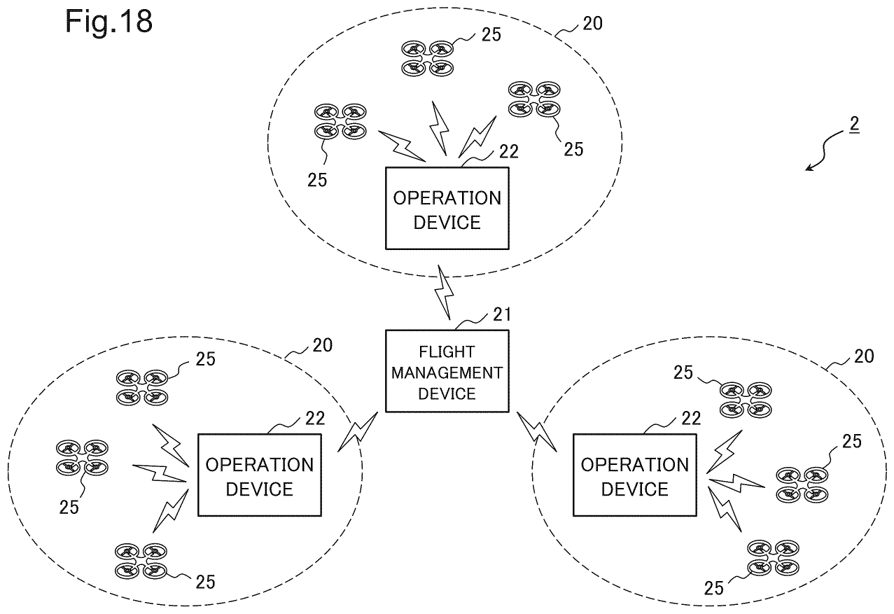

FIG. 18 is a conceptual diagram illustrating an example of a configuration of a flight management system 2 according to the present example embodiment. The flight management system 2 includes a flight management device 21, an operation device 22, and an unmanned aircraft 25. FIG. 18 illustrates three sets of combinations (also referred to as flight unit 20) of the operation device 22 and the plurality of unmanned aircrafts 25. The number of the flight units 20 is not limited to three. The number of the flight units 20 may be one, two, or four or more. The number of the operation devices 22 and the number of the unmanned aircrafts 25 included in each of the flight units 20 are not particularly limited.

The flight management device 21 has a configuration similar to that of the flight management device 11 of the first example embodiment. The flight management device 21 manages flight of the unmanned aircraft 25 to be managed. The flight management device 21 is communicably connected to the operation device 22. The flight management device 21 communicates with the unmanned aircraft 25 via the operation device 22.

The flight management device 21 acquires flight plan information about the flight of each unmanned aircraft 25. The flight management device 21 acquires transmission information (remote ID information) including a remote identifier (ID) of the unmanned aircraft 25 flying according to the flight plan. The flight management device 21 stores shared information in which the flight plan information and the remote ID information are associated with each other. The shared information for each flight plan of the unmanned aircraft 25 is shared between the flight management device 21, the operation device 22 that remotely operates the unmanned aircraft 25, and the unmanned aircraft 25 to be operated.

The operation device 22 has a configuration similar to that of the operation device 12 of the first example embodiment. The operation device 22 differs from the operation device 12 of the first example embodiment in that the plurality of unmanned aircrafts 25 performing a mission according to a flight plan is guided according to position information of the unmanned aircrafts 25. The operation device 22 remotely operates the unmanned aircraft 25 to be operated included in the same flight unit 20. The operation device 22 is communicably connected to the flight management device 21 and the unmanned aircraft 25.

Flight plan information including a flight plan is input to the operation device 22 via an input device (not illustrated). The operation device 22 associates the input flight plan information with the remote ID information of the unmanned aerial vehicle assigned to the flight plan information to generate shared information. The operation device 22 records the generated shared information. The operation device 22 also transmits the generated shared information to the flight management device 21. Further, the operation device 22 transmits the input flight plan information to the unmanned aircraft 25 assigned to the flight plan information. In this manner, the shared information for each flight plan of the unmanned aircraft 25 is shared between the flight management device 21, the operation device 22 for remotely operating the unmanned aircraft 25, and the unmanned aircraft 25 to be operated.

The operation device 22 remotely operates the unmanned aircraft 25 associated with the flight plan information according to the flight plan included in the flight plan information. When the scheduled departure time included in the flight plan comes, the operation device 22 activates the unmanned aircraft 25 to which the flight plan is assigned. The operation device 22 receives the transmission information including the remote ID information from the activated unmanned aircraft 25. The operation device 22 updates the shared information in accordance with the received remote ID information. The operation device 22 transmits the updated shared information to the flight management device 21. When there is no change in the flight plan, the operation device 22 may transmit only the updated remote ID information to the flight management device 21. When the flight plan is changed, the operation device 22 transmits shared information including the changed flight plan and the updated remote ID information to the flight management device 21.

The operation device 22 transmits an operation signal related to the remote ID information of the unmanned aircraft 25 and the flight plan to the unmanned aircraft 25. The operation device 22 remotely operates the unmanned aircraft 25 from the departure place to the destination place according to the remote ID information and the flight plan of the unmanned aircraft 25. In a case where the distance between the departure place and the destination place is long, the operation device 22 remotely operates the unmanned aircraft 25 via the relay.

The operation device 22 calculates the positional relationship between the plurality of unmanned aircrafts 25 according to the position information of the unmanned aircrafts 25. The operation device 22 generates, for each unmanned aircraft 25, a guidance signal for the plurality of unmanned aircrafts 25 to fly at intervals from one another according to the calculated positional relationship between the plurality of unmanned aircrafts 25. The guidance signal is a type of operation signal. The operation device 22 transmits a guidance signal generated for each unmanned aircraft 25 towards each of the plurality of unmanned aircrafts 25.

The unmanned aircraft 25 has a configuration similar to that of the unmanned aircraft 15 of the first example embodiment. The unmanned aircraft 25 is different from the unmanned aircraft 15 of the first example embodiment in that flight control is performed according to a guidance signal transmitted from the operation device 22. The unmanned aircraft 25 receives flight plan information from the operation device 22. The unmanned aircraft 25 stores shared information in which the remote ID information of the unmanned aircraft is associated with the flight plan information. Upon receiving update information of the registered flight plan information from the operation device 22, the unmanned aircraft 25 updates the registered flight plan information with the update information.

The unmanned aircraft 25 flies from the departure place to the destination place included in the flight plan information in response to the operation signal of the operation device 22. The unmanned aircraft 25 is communicably connected to the operation device 22. The unmanned aircraft 25 communicates with the operation device 22. When the scheduled departure time included in the flight plan comes, the unmanned aircraft 25 is activated according to the activation control of the operation device 22. When activated, the unmanned aircraft 25 generates the remote ID information according to the position information and the time information at the time. The unmanned aircraft 25 transmits transmission information including remote ID information at a predetermined timing. The unmanned aircraft 25 updates the shared information according to the generated remote ID information. The transmission information transmitted from the unmanned aircraft 25 is received by the operation device 22.

The unmanned aircraft 25 receives an operation signal related to the remote ID information and the flight plan from the operation device 22. The unmanned aircraft 25 is remotely operated from the departure place to the destination place by the operation device 22 according to the remote ID information of the unmanned aircraft 25 and the flight plan. In a case where the distance between the departure place and the destination place is large, the unmanned aircraft 25 is remotely operated by the operation device 22 via a relay. During flight, the unmanned aircraft 25 transmits transmission information including remote ID information at a predetermined timing. The transmission information transmitted from the unmanned aircraft 25 is received by the operation device 22.

The unmanned aircraft 25 also receives, from the operation device 22, a guidance signal generated for the unmanned aircraft 25. The guidance signal is an operation signal for the plurality of unmanned aircrafts 25 operated by the operation device 22 to fly at a safe spacing from one another. The unmanned aircraft 25 is flight-controlled in response to the guidance signal and the operation signal. As a result, the plurality of unmanned aircrafts 25 can maintain a safe spacing from one another.

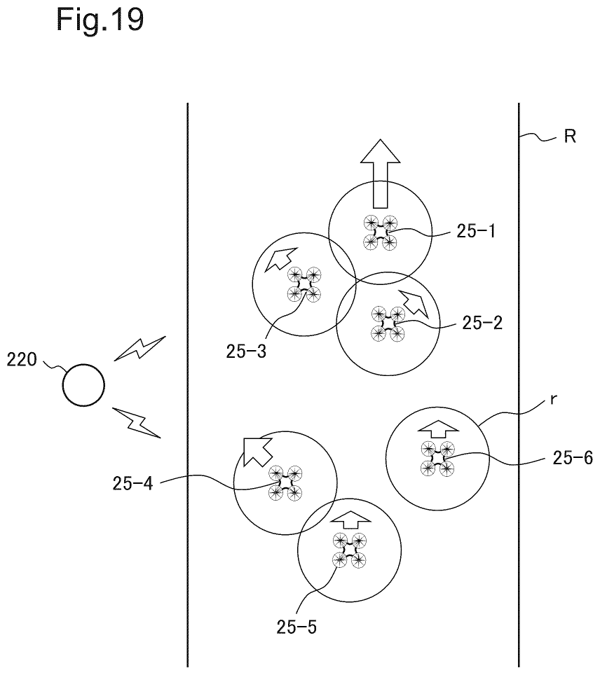

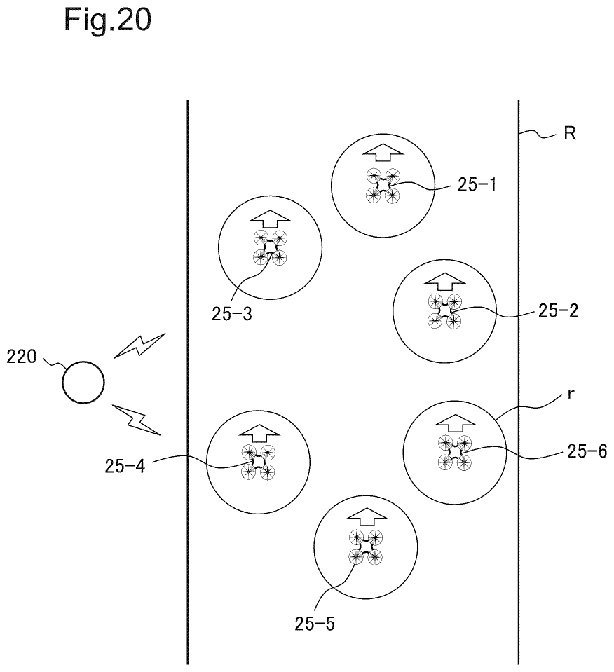

FIGS. 19 to 20 are conceptual diagrams for describing an example of guidance control of the unmanned aircraft 25. FIGS. 19 to 20 are diagrams of the flight route R viewed from above. The unmanned aircrafts 25-1 to 25-6 using the flight route R moves from the bottom to the top of the paper. In the example of FIGS. 19 to 20, an operation signal from the operation device 22 is transmitted from a relay 220 disposed near the flight route R towards the unmanned aircraft 25. Communication means between the operation device 22 and the relay 220 is not particularly limited. The operation device 22 may transmit an operation signal to the unmanned aircraft 25 without via the relay 220. For example, the positional relationship between the plurality of unmanned aircrafts 25 as illustrated in FIGS. 19 to 20 is displayed on a screen of a terminal device of an administrator who manages flight of the plurality of unmanned aircrafts 25 using the flight management device 21.

An occupation range r is set around the unmanned aircraft 25. The occupation range r is a range of spheres or circles around each of the plurality of unmanned aircrafts 25. The occupation range r is set to a size in which the plurality of unmanned aircrafts 25 flying on the flight route R is less likely to collide with each other. The occupation range r may be set to the same size or different sizes for the plurality of unmanned aircrafts 25. For example, the occupation range r is set according to the size of the unmanned aircraft 25. For example, the occupation range r is set according to the mission carried out by the unmanned aircraft 25. For example, the occupation range r is set according to the size and degree of importance of the cargo carried by the unmanned aircraft 25. For example, the occupation range r is set according to the speed of the unmanned aircraft 25. In FIGS. 19 to 20, the occupation range r is indicated by a solid circle. In the examples of FIGS. 19 to 20, the difference in speed of the unmanned aircraft 25 is indicated by the length of the arrow. The longer the arrow, the faster the speed, and the shorter the arrow, the slower the speed.

In the example of FIG. 19, six unmanned aircrafts 25-1 to 25-6 are flying on the flight route R. In the scene of FIG. 19, the occupation ranges r of the unmanned aircrafts 25-1 to 25-3 overlap. The occupation ranges r of the unmanned aircrafts 25-4 to 25-5 also overlap. In such a case, the operation device 22 generates a guidance signal for the unmanned aircrafts 25-1 to 25-5. The operation device 22 may also generate a guidance signal for the unmanned aircraft 25-6 whose occupation range r does not overlap. The operation device 22 generates a guidance signal for the occupation ranges r of the unmanned aircrafts 25-1 to 25-5 to no longer overlap.

In the example of FIG. 19, the operation device 22 generates a guidance signal for increasing the speed of the unmanned aircraft 25-1. The operation device 22 generates a guidance signal for moving to the left frontward relative to the unmanned aircraft 25-2. The operation device 22 generates a guidance signal for moving to the right frontward relative to the unmanned aircraft 25-3. The operation device 22 generates a guidance signal for moving to the left frontward relative to the unmanned aircraft 25-4. The operation device 22 generates a guidance signal for slowing down the unmanned aircraft 25-5. The operation device 22 does not generate a guidance signal for the unmanned aircraft 25-6.

In the example of FIG. 19, the unmanned aircrafts 25-1 to 25-5, which has received the guidance signal generated by the operation device 22, controls themselves according to the guidance signal. The unmanned aircraft 25-1 increases its speed in response to the guidance signal. The unmanned aircraft 25-2 moves to the left frontward in response to the guidance signal. The unmanned aircraft 25-3 moves to the right frontward in response to the guidance signal. The unmanned aircraft 25-4 moves to the left frontward in response to the guidance signal. The unmanned aircraft 25-5 slows down in response to the guidance signal. The unmanned aircraft 25-6 continues the flight in response to the operation signal.

The state of FIG. 20 is a conceptual diagram illustrating an example of a state in which the unmanned aircrafts 25-1 to 25-5 are guided according to the guidance signal. As a result of the flight control of the unmanned aircraft 25 according to the guidance signal by the operation device 22, as illustrated in FIG. 20, the overlapping of the occupation ranges r of the unmanned aircrafts 25-1 to 25-6 is eliminated.

### (Operation)

Next, an operation of the flight management system 2 according to the present example embodiment will be described with reference to the drawings. Hereinafter, operations of the operation device 22 and the unmanned aircraft 25 constituting the flight management system 2 will be individually described. The operation of the flight management device 21, the sharing of flight plan information by the operation device 22, and the activation control of the unmanned aircraft 25 are the same as those in the first example embodiment, and thus the description thereof will be omitted.

### [Operation Device]

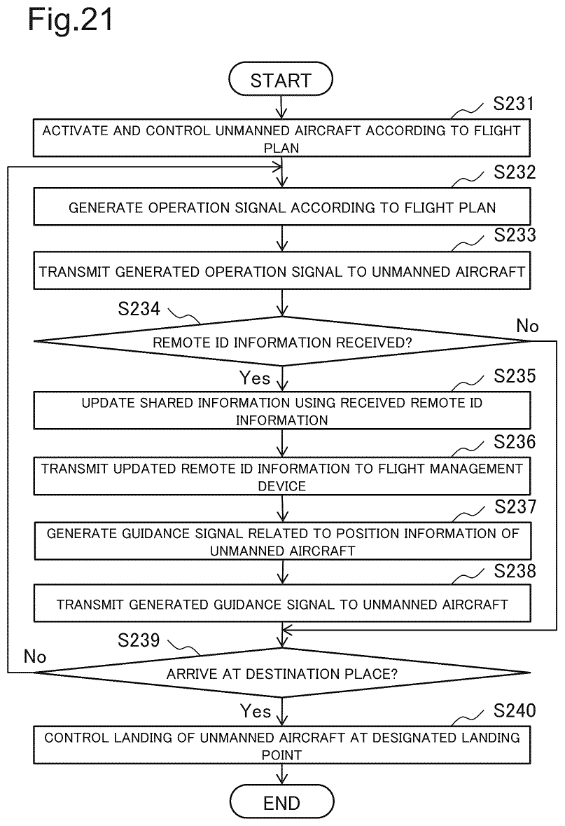

FIG. 21 is a flowchart for describing an example of the operation of the operation device 22. FIG. 21 relates to controlling, according to a flight plan, the unmanned aircraft 25 to which the flight plan is assigned. In the description along the flowchart of FIG. 21, the operation device 22 will be described as an operation subject.

In FIG. 21, first, the operation device 22 activates and controls the unmanned aircraft 25 to which the flight plan is assigned according to the flight plan (step S231).

Next, the operation device 22 generates an operation signal according to the flight plan (step S232). The operation signal is input by the operator of the unmanned aircraft 25. In a case where automatic flight of the unmanned aircraft 25 is possible, the operation signal may be automatically generated according to the flight plan.

Next, the operation device 22 transmits the generated operation signal to the unmanned aircraft 25 (step S233). The unmanned aircraft 25 performs a mission according to the flight plan by operating in response to the operation signal.

When the remote ID information is received from the unmanned aircraft 25 executing the mission according to the flight plan (Yes in step S234), the operation device 22 updates the shared information using the received remote ID information (step S235).

Next, the operation device 22 transmits the updated remote ID information to the flight management device 21 (step S236).

Next, the operation device 22 generates, for the unmanned aircraft 25 to be guided, guidance information related to the position information of the unmanned aircraft 25 included in the remote ID information (step S237). The operation device 22 generates a guidance signal depending on the positional relationship between the plurality of unmanned aircrafts 25 executing the flight plan.

Next, the operation device 22 transmits the generated guidance signal to the unmanned aircraft 25 to be guided (step S238). In a case where it is not necessary to generate a guidance signal depending on the positional relationship between the plurality of unmanned aircrafts 25, steps S237 and S238 are omitted.

After step S238 or in a case of No in step S234, in a case where the operation device 22 has not arrived at the destination place (No in step S239), the process returns to step S232. On the another hand, when the unmanned aircraft 25 arrives at the destination place (Yes in step S239), the operation device 22 controls landing of the unmanned aircraft 25 at the designated landing point (step S240).

### [Unmanned Aircraft]

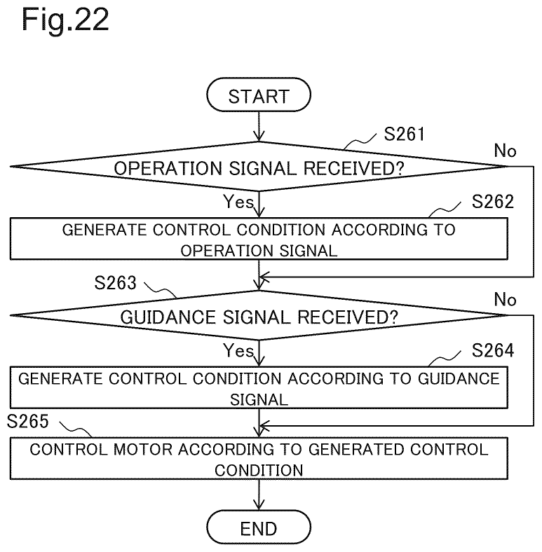

FIG. 22 is a flowchart for describing an example of the operation of the unmanned aircraft 25. FIG. 22 relates to flight control process according to an operation signal of the operation device 22. The flight control process of FIG. 22 is executed instead of the flight control process (FIG. 17) in the first example embodiment. In the description along the flowchart of FIG. 22, the unmanned aircraft 25 will be described as the operation subject.

In FIG. 22, first of all, upon receiving the operation signal (Yes in step S261), the unmanned aircraft 25 generates a control condition for the motor in accordance with the operation signal (step S262).

After step S262 or in a case of No in step S261, in a case where a guidance signal has been received (Yes in step S263), the unmanned aircraft 25 generates a control condition of the motor according to the guidance signal (step S264). In a case where the operation signal and the guidance signal are received simultaneously, the unmanned aircraft 25 gives priority to the guidance signal to generate a control condition for the motor.

After step S264 or in a case of No in step S263, the unmanned aircraft 25 controls the motor according to the generated control conditions (step S265). The unmanned aircraft 25 flies according to the rotation state of the propeller driven according to the control of the motor. In a case where neither the operation signal nor the guidance signal is received, the flight control may be continued according to the control condition generated at the timing of the previous flight control. After step S265, the process proceeds to step S153 in FIG. 16 in the first example embodiment.

As described above, the flight management system of the present example embodiment includes the flight management device, the operation device, and the unmanned aircraft. The flight management system manages flight of an unmanned aircraft that flies according to a flight plan. The flight plan information includes identification information, a departure place, a scheduled departure time, a destination place, and a scheduled arrival time of the flight plan.

The unmanned aircraft holds shared information in which transmission information including identification information, position information, and time information of the unmanned aircraft is associated with flight plan information including a flight plan. The unmanned aircraft flies according to the flight plan while transmitting transmission information at a predetermined timing.

In response to the input of the flight plan information, the operation device assigns the flight plan included in the flight plan information to the unmanned aircraft to be managed. The operation device generates shared information in which transmission information of the unmanned aircraft to which the flight plan is assigned is associated with the flight plan information. The operation device transmits the generated shared information to the flight management device, and the operation device transmits flight plan information to the unmanned aircraft to which the flight plan is assigned. The operation device activates the unmanned aircraft in accordance with the flight plan. The operation device transmits an operation signal for operating the unmanned aircraft to the activated unmanned aircraft. The operation device receives the transmission information transmitted from the plurality of unmanned aircrafts flying according to the flight plan. The operation device transmits a guidance signal for changing the positional relationship of the plurality of unmanned aircrafts to each of the plurality of unmanned aircrafts according to the position information included in the transmission information transmitted from each of the plurality of unmanned aircrafts.

The flight management device shares shared information with the unmanned aircraft to be managed. The flight management device acquires transmission information transmitted from the unmanned aircraft that flies according to the flight plan and updates the shared information.

The flight management system of the present example embodiment shares shared information including transmission information of an unmanned aircraft and flight plan information between the unmanned aircraft that flies according to a flight plan and a flight management device that manages the unmanned aircraft. Therefore, according to the present example embodiment, by updating the shared information as needed according to the transmission information transmitted from the unmanned aircraft, the flight management device can accurately manage the flight situation of the unmanned aircraft. According to the present example embodiment, the plurality of unmanned aircrafts can safely fly by transmitting a guidance signal to the plurality of unmanned aircrafts according to the positional relationship of the plurality of unmanned aircrafts.

### Third Example Embodiment

Next, a flight management system according to a third example embodiment will be described with reference to the drawings. In the flight management system of the present example embodiment, each unmanned aircraft performs autonomous control in accordance with a positional relationship of a plurality of unmanned aircrafts executing a mission according to a flight plan.

### (Configuration)

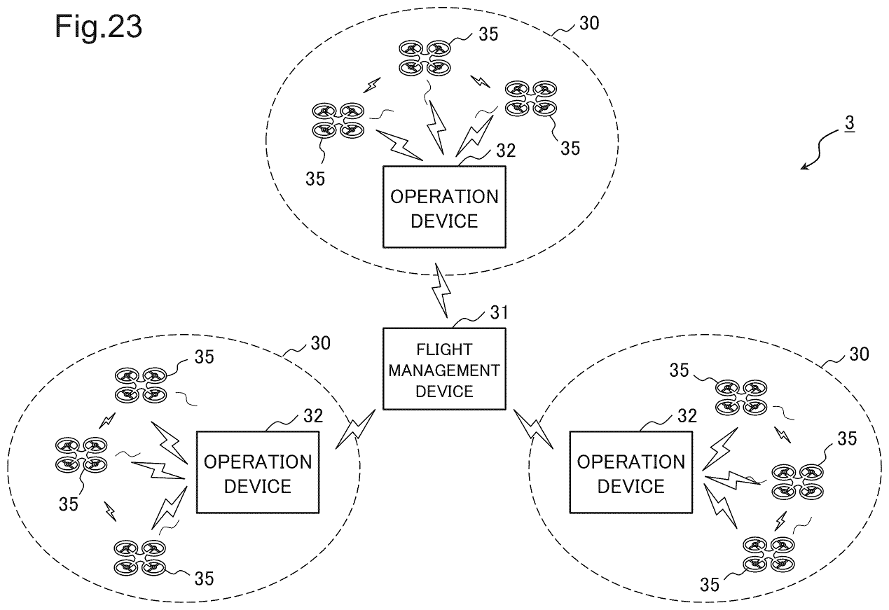

FIG. 23 is a conceptual diagram illustrating an example of a configuration of a flight management system 3 according to the present example embodiment. The flight management system 3 includes a flight management device 31, an operation device 32, and an unmanned aircraft 35. FIG. 23 illustrates three sets of combinations (also referred to as flight unit 30) of the operation device 32 and the plurality of unmanned aircrafts 35. The number of the flight units 30 is not limited to three. The number of the flight units 30 may be one, two, or four or more. The number of the operation devices 32 and the unmanned aircrafts 35 included in each of the flight units 30 is not particularly limited.

The flight management device 31 has a configuration similar to that of the flight management device 11 of the first example embodiment. The flight management device 31 manages flight of the unmanned aircraft 35 to be managed. The flight management device 31 is communicably connected to the operation device 32. The flight management device 31 communicates with the unmanned aircraft 35 via the operation device 32.

The flight management device 31 acquires flight plan information about the flight of each unmanned aircraft 35. The flight management device 31 acquires transmission information (remote ID information) including a remote identifier (ID) of the unmanned aircraft 35 flying according to the flight plan. The flight management device 31 stores shared information in which the flight plan information and the remote ID information are associated with each other. The shared information for each flight plan of the unmanned aircraft 35 is shared between the flight management device 31, the operation device 32 that remotely operates the unmanned aircraft 35, and the unmanned aircraft 35 to be operated.

The operation device 32 has a configuration similar to that of the operation device 12 of the first example embodiment or the operation device 22 of the second example embodiment. The operation device 32 remotely operates the unmanned aircraft 35 to be operated included in the same flight unit 20. The operation device 32 is communicably connected to the flight management device 31 and the unmanned aircraft 35.

Flight plan information including a flight plan is input to the operation device 32 via an input device (not illustrated). The operation device 32 associates the input flight plan information with the remote ID information of the unmanned aerial vehicle assigned to the flight plan information to generate shared information. The operation device 32 records the generated shared information. The operation device 32 also transmits the generated shared information to the flight management device 31. Further, the operation device 32 transmits the input flight plan information to the unmanned aircraft 35 assigned to the flight plan information. In this manner, the shared information for each flight plan of the unmanned aircraft 35 is shared between the flight management device 31, the operation device 32 for remotely operating the unmanned aircraft 35, and the unmanned aircraft 35 to be operated.

The operation device 32 remotely operates the unmanned aircraft 35 associated with the flight plan information according to the flight plan included in the flight plan information. When the scheduled departure time included in the flight plan comes, the operation device 32 activates the unmanned aircraft 35 to which the flight plan is assigned. The operation device 32 receives the transmission information including the remote ID information from the activated unmanned aircraft 35. The operation device 32 updates the shared information in accordance with the received remote ID information. The operation device 32 transmits the updated shared information to the flight management device 31. When there is no change in the flight plan, the operation device 32 may transmit only the updated remote ID information to the flight management device 31. When the flight plan is changed, the operation device 32 transmits shared information including the changed flight plan and the updated remote ID information to the flight management device 31.

The operation device 32 transmits an operation signal related to the remote ID information of the unmanned aircraft 35 and the flight plan to the unmanned aircraft 35. The operation device 32 remotely operates the unmanned aircraft 35 from the departure place to the destination place according to the remote ID information of the unmanned aircraft 35 and the flight plan. In a case where the distance between the departure place and the destination place is long, the operation device 32 remotely operates the unmanned aircraft 35 via the relay.

In a case of a configuration similar to that of the operation device 22 according to the second example embodiment, the operation device 32 calculates the positional relationship of the plurality of unmanned aircrafts 35 according to the position information of the unmanned aircrafts 35. The operation device 32 generates, for each unmanned aircraft 35, a guidance signal for the plurality of unmanned aircrafts 35 to fly at intervals from one another according to the calculated positional relationship between the plurality of unmanned aircrafts 35. The guidance signal is a type of operation signal. The operation device 32 transmits a guidance signal generated for each unmanned aircraft 35 towards each of the plurality of unmanned aircrafts 35.

The unmanned aircraft 35 has a configuration similar to that of the unmanned aircraft 15 of the first example embodiment or the unmanned aircraft 25 of the second example embodiment. The unmanned aircraft 35 is different from the unmanned aircraft 15 of the first example embodiment and the unmanned aircraft 25 of the second example embodiment in that autonomous control is performed according to position information included in remote ID information transmitted from another unmanned aircraft 35 flying around the host unmanned aircraft 35. The unmanned aircraft 35 receives flight plan information from the operation device 32. The unmanned aircraft 35 stores shared information in which the remote ID information of the unmanned aircraft is associated with the flight plan information. Upon receiving update information of the registered flight plan information from the operation device 32, the unmanned aircraft 35 updates the registered flight plan information with the update information.

The unmanned aircraft 35 flies from the departure place to the destination place included in the flight plan information in response to the operation signal of the operation device 32. The unmanned aircraft 35 is communicably connected to the operation device 32. The unmanned aircraft 35 communicates with the operation device 32. When the scheduled departure time included in the flight plan comes, the unmanned aircraft 35 is activated according to the activation control of the operation device 32. When activated, the unmanned aircraft 35 generates the remote ID information according to the position information and the time information at the time. The unmanned aircraft 35 transmits transmission information including remote ID information at a predetermined timing. The unmanned aircraft 35 updates the shared information according to the generated remote ID information. The transmission information transmitted from the unmanned aircraft 35 is received by the operation device 32. The transmission information transmitted from the unmanned aircraft 35 is received by the surrounding unmanned aircraft 35.

The unmanned aircraft 35 receives an operation signal related to the remote ID information and the flight plan from the operation device 32. The unmanned aircraft 35 is remotely operated from the departure place to the destination place by the operation device 32 according to the remote ID information of the unmanned aircraft 35 and the flight plan. In a case where the distance between the departure place and the destination place is large, the unmanned aircraft 35 is remotely operated by the operation device 32 via a relay. During flight, the unmanned aircraft 35 transmits transmission information including remote ID information at a predetermined timing. The transmission information transmitted from the unmanned aircraft 35 is received by the operation device 32.

In a case of a configuration similar to that of the unmanned aircraft 25 of the second example embodiment, the unmanned aircraft 35 receives the guidance signal generated for the unmanned aircraft 35 from the operation device 32. The guidance signal is an operation signal for the plurality of unmanned aircrafts 35 operated by the operation device 32 to fly at a safe spacing from one another. The unmanned aircraft 35 is flight-controlled according to the operation signal and the guidance signal. As a result, the plurality of unmanned aircrafts 35 can maintain a safe spacing from one another.

The unmanned aircraft 35 acquires position information of another unmanned aircraft 35 (another unmanned aircraft) flying on the flight route. The position information of another unmanned aircraft is included in the remote ID information transmitted from the another unmanned aircraft. In a case where the position information of the another unmanned aircraft is acquired, the unmanned aircraft 35 calculates the positional relationship between the another unmanned aircraft and the unmanned aircraft 35 using the position information of the another unmanned aircraft. For example, the unmanned aircraft 35 calculates the distance between the another unmanned aircraft and the unmanned aircraft 35 as the positional relationship between the another unmanned aircraft and the unmanned aircraft 35. In a case where the distance between the another unmanned aircraft and the unmanned aircraft 35 is less than the predetermined distance, the unmanned aircraft 35 calculates the control target position in such a way as to move away from the another unmanned aircraft. For example, the unmanned aircraft 35 sets the control target position in a direction away from the position of the another unmanned aircraft. The unmanned aircraft 35 moves the unmanned aircraft 35 toward the calculated control target position.

The unmanned aircraft 35 may perform emergency control of the unmanned aircraft 35 according to measurement data or position information of the another unmanned aircraft by a sensor mounted on the unmanned aircraft 35. For example, in a case where it is determined that continuation of the autonomous flight control is difficult due to a sudden change in the weather, a sudden strong wind, a thunderstorm, or the like, the unmanned aircraft 35 performs emergency landing control. For example, a situation in which it is difficult for to perform autonomous control may occur because the unmanned aircrafts 35 are densely populated or the another unmanned aircraft 35 having a large difference in speed approach the unmanned aircraft 35. In such a case, the unmanned aircraft 35 transitions from the autonomous flight control mode to the emergency landing control mode. For example, the unmanned aircraft 35 may be configured to transition to the emergency landing control mode upon receiving a forced landing instruction from a medical helicopter or the like flying near the flight route of the unmanned aircraft 35.

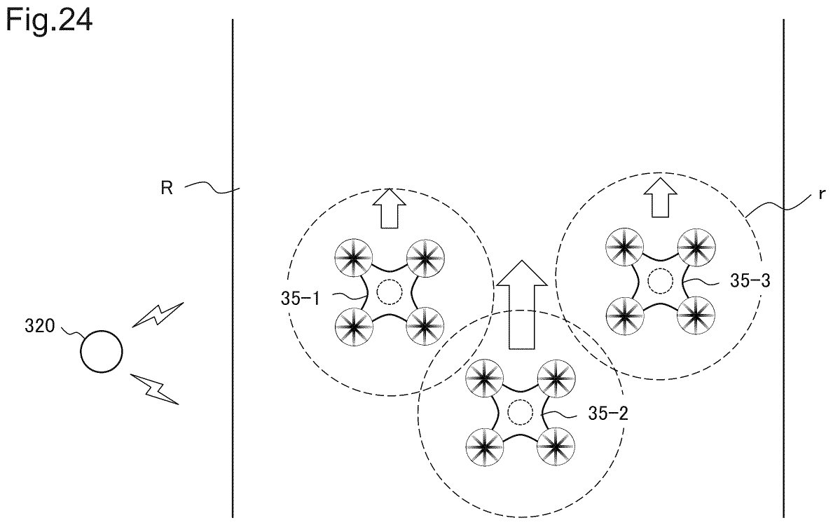

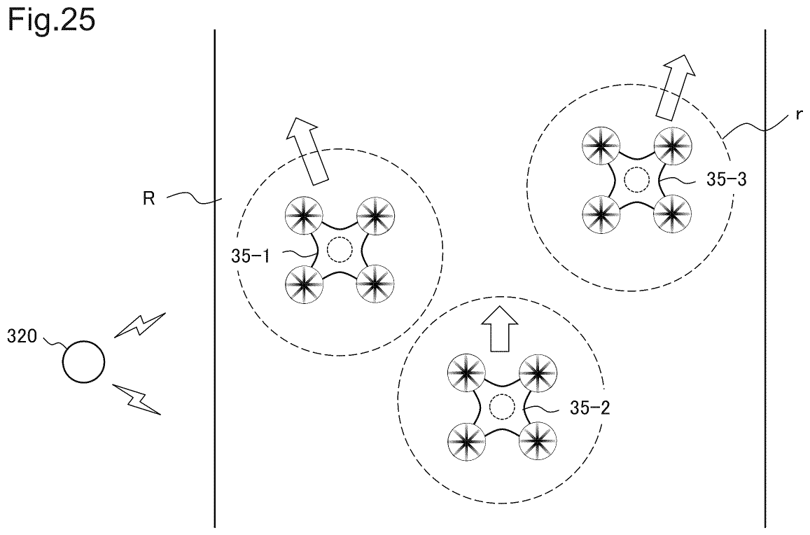

FIGS. 24 to 25 are conceptual diagrams for describing an example of autonomous control of the unmanned aircraft 35. In FIGS. 24 to 25, the river flows from the bottom (upstream) to the top (downstream) of the paper. The unmanned aircraft 35 flies on the flight route R in accordance with the control of the operation device 32. An occupation range r is set around each of the unmanned aircrafts 35-1 to 35-3. In FIGS. 24 to 25, the occupation range r is indicated by a dashed circle. In the examples of FIGS. 24 to 25, the difference in speed of the unmanned aircrafts 35-1 to 35-3 is indicated by the length of the arrows. The longer the arrow, the faster the speed, and the shorter the arrow, the slower the speed. In the example of FIGS. 24 to 25, an operation signal from the operation device 32 is transmitted from a relay 320 disposed near the flight route R towards the unmanned aircraft 35. Communication means between the operation device 32 and the relay 320 is not particularly limited. The operation device 32 may transmit an operation signal to the unmanned aircraft 35 without via the relay 320. For example, the positional relationship between the plurality of unmanned aircrafts 25 as illustrated in FIGS. 24 to 25 is displayed on a screen of a terminal device of an administrator who manages flight of the plurality of unmanned aircrafts 35 using the flight management device 31.

In the example of FIG. 24, three unmanned aircrafts 35-1 to 35-3 are flying on the flight route R. The scene of FIG. 24 is a situation in which the unmanned aircraft 35-1 having a high speed flies from behind the unmanned aircraft 35-3 and the unmanned aircraft 35-2 flying at a normal speed. The occupation range r of each of the unmanned aircraft 35-1 and the unmanned aircraft 35-3 overlaps with the occupation range r of the unmanned aircraft 35-2. In such a case, the unmanned aircrafts 35-1 to 35-3 control their own propeller in such a way that their occupation ranges r do not overlap. That is, the unmanned aircrafts 35-1 to 35-3 perform cooperative control in such a way that the occupation ranges r do not overlap each other.

The scene of FIG. 25 is a situation as a result of execution of the cooperative control by the unmanned aircrafts 35-1 to 35-3 after the scene of FIG. 24. The unmanned aircraft 35-1 moves to the left frontward with an increased speed in such a way as to move away from the unmanned aircraft 35-2. The unmanned aircraft 35-2 reduces its speed so as not to approach the unmanned aircraft 35-1 and the unmanned aircraft 35-2. The unmanned aircraft 35-3 moves to the right frontward with an increased speed in such a way as to move away from the unmanned aircraft 35-2. As a result of the cooperative control as described above, there is no overlap of the occupation ranges r of the unmanned aircrafts 35-1 to 35-3 as in FIG. 25.

### (Operation)

Next, an operation of the flight management system 3 according to the present example embodiment will be described with reference to the drawings. Hereinafter, the operation of the unmanned aircraft 35 constituting the flight management system 3 will be described. Operations of the flight management device 31 and the operation device 32 and activation control of the unmanned aircraft 35 are the same as those in the first example embodiment and the second example embodiment, and thus description thereof is omitted.

### [Unmanned Aircraft]

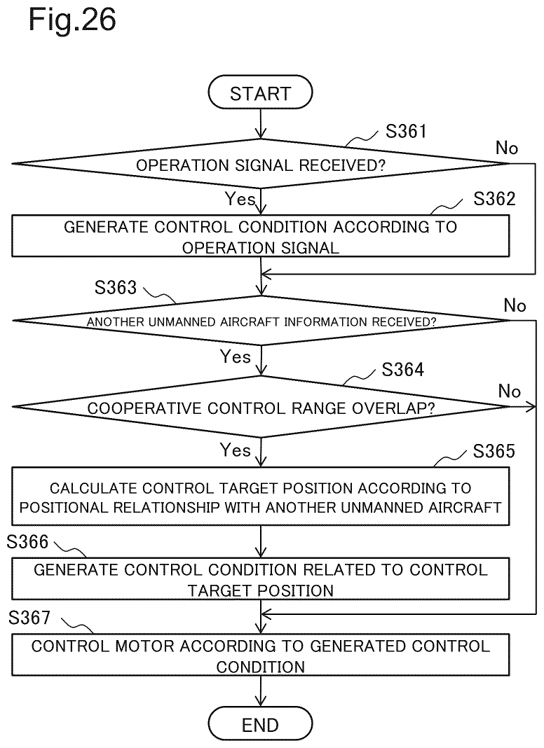

FIG. 26 is a flowchart for describing an example of the operation of the unmanned aircraft 35. FIG. 26 relates to the flight control process according to an operation signal of the operation device 32. The flight control process of FIG. 26 is executed instead of the flight control process (FIG. 17) in the first example embodiment. In the flight control process of FIG. 26, generation of the guidance signal is omitted. In the description along the flowchart of FIG. 26, the unmanned aircraft 35 will be described as the operation subject.

In FIG. 26, first of all, upon receiving the operation signal (Yes in step S361), the unmanned aircraft 35 generates a control condition for the motor in accordance with the operation signal (step S362).

After step S362 or in a case of No in step S361, in a case where another unmanned aircraft signal has been received (Yes in step S363), the unmanned aircraft 35 determines whether the cooperative control ranges of the unmanned aircraft and the another unmanned aircraft overlap (step S364). In a case where the another unmanned aircraft signal has not been received (No in step S363), the process proceeds to step S367.

In a case where the cooperative control ranges of the unmanned aircraft and the another unmanned aircraft overlap (Yes in step S364), the unmanned aircraft 35 calculates the control target position of the unmanned aircraft according to the positional relationship with the another unmanned aircraft (step S365).

Next, the unmanned aircraft 35 generates a control condition of the motor according to the control target position (step S366). In a case where the cooperative control ranges overlap, the unmanned aircraft 35 prioritizes the control condition according to the control target position over the control condition according to the operation signal.

After step S366, or in a case of No in step S363 or step S364, the unmanned aircraft 35 controls the motor according to the generated control conditions (step S367). The unmanned aircraft 35 flies according to the rotation state of the propeller driven according to the control of the motor. In a case where neither the operation signal nor the another unmanned aircraft signal is received, the flight control may be continued according to the control condition generated at the timing of the previous flight control. After step S367, the process proceeds to step S153 in FIG. 16 in the first example embodiment.

### [Emergency Landing Control]

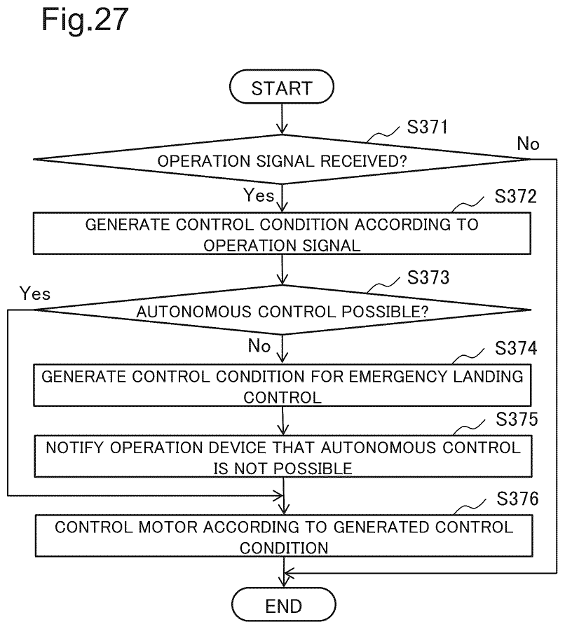

FIG. 27 is a flowchart for describing another example of the operation of the unmanned aircraft 35. FIG. 27 relates to emergency landing control executed by the unmanned aircraft 35 in accordance with sensor data detected by a sensor mounted on the unmanned aircraft 35 and position information included in a remote ID transmitted from the another unmanned aircraft. In the emergency landing control of FIG. 27, processing regarding overlapping of the cooperative control range with the another unmanned aircraft is omitted. The emergency landing control in FIG. 27 is executed instead of the flight control process (FIG. 17) in the first example embodiment. In the description along the flowchart of FIG. 27, the unmanned aircraft 35 will be described as the operation subject.

In FIG. 27, first of all, upon receiving the operation signal (Yes in step S371), the unmanned aircraft 35 generates a control condition for the motor in accordance with the operation signal (step S372).

After step S372 or in a case of No in step S371, in a case where the autonomous control is not possible (No in step S373), the unmanned aircraft 35 generates a control condition of the emergency landing control (step S374). The unmanned aircraft 35 notifies the operation device 32 that the autonomous control is impossible (step S375). The control condition of the emergency landing control is prioritized over the control condition related to the operation signal. In a case where the autonomous control is possible (Yes in step S373), the process proceeds to step S376.

After step S375 or in a case of No in step S373, the unmanned aircraft 35 controls the motor according to the generated control conditions (step S376). In a case subsequent to step S375, the unmanned aircraft 35 lands in accordance with the control condition of the emergency landing control. In a case of No in step S373, the unmanned aircraft 35 flies according to the rotation state of the propeller driven according to the control of the motor. In a case where the operation signal is not received, the flight control may be continued according to the control condition generated at the timing of the previous flight control. After step S376, the process proceeds to step S153 in FIG. 16 in the first example embodiment.

FIG. 27 illustrates the process of performing the emergency landing control in a case where it is determined that the autonomous control is impossible. For example, the unmanned aircraft 35 may execute autonomous control according to a state of the unmanned aircraft 35 detected by a sensor mounted on the unmanned aircraft 35 or a situation around the unmanned aircraft 35. For example, the autonomous control includes causing the unmanned aircraft 35 to be distant from the another unmanned aircraft 35 in a case of a sudden approach to the another unmanned aircraft. In a case where the autonomous control is executed, the unmanned aircraft 35 transmits a notification that the autonomous control is executed to the flight management device 31.

For example, the unmanned aircraft 35 determines whether the flight plan is allowed to be executed according to the situation recognized by the sensor mounted on the unmanned aircraft. In a case where it is determined that the flight plan is allowed to be executed, the unmanned aircraft 35 continues flight according to the flight plan. In a case where it is determined that the flight plan is not allowed to be executed, the unmanned aircraft 35 executes control different from the flight plan, and transmits a notification that the control different from the flight plan has been executed to the flight management device 31. For example, in a case where the weather suddenly changes, wind and rain become strong, and it is difficult to continue the flight, the unmanned aircraft 35 determines that the flight plan is not allowed to be executed. For example, in a case where many birds and insects fly on the flight route and it is difficult to continue the flight, the unmanned aircraft 35 determines that the flight plan is not allowed to be executed. For example, in a case where there are many other unmanned aircrafts 35 flying on the flight route, and it is difficult to continue the flight, the unmanned aircraft 35 determines that the flight plan is not allowed to be executed. The criterion for determining that the flight plan is not allowed to be executed is not particularly limited.

The unmanned aircraft 35 may have the function of recommending the operation content to the operation device 32 depending on the situation recognized by the sensors. For example, the unmanned aircraft 35 may recommend slowing down or changing altitude depending on the situation around the unmanned aircraft. In this way, the flight of the unmanned aircraft 35 can be dynamically controlled according to the operation signal transmitted from the operation device 32 according to the recommendation from the unmanned aircraft 35 by the interactive communication between the unmanned aircraft 35 and the operation device 32.

As described above, the flight management system of the present example embodiment includes the flight management device, the operation device, and the unmanned aircraft. The flight management system manages flight of an unmanned aircraft that flies according to a flight plan. The flight plan information includes identification information, a departure place, a scheduled departure time, a destination place, and a scheduled arrival time of the flight plan.

The unmanned aircraft holds shared information in which transmission information including identification information, position information, and time information of the unmanned aircraft is associated with flight plan information including a flight plan. The unmanned aircraft flies according to the flight plan while transmitting transmission information at a predetermined timing. The unmanned aircraft receives transmission information transmitted from another unmanned aircraft flying around the host unmanned aircraft. According to the position information included in the received transmission information, the unmanned aircraft calculates a control target position for providing a distance from another unmanned aircraft. The unmanned aircraft executes control to move the unmanned aircraft toward the calculated control target position.

In response to the input of the flight plan information, the operation device assigns the flight plan included in the flight plan information to the unmanned aircraft to be managed. The operation device generates shared information in which transmission information of the unmanned aircraft to which the flight plan is assigned is associated with the flight plan information. The operation device transmits the generated shared information to the flight management device, and the operation device transmits flight plan information to the unmanned aircraft to which the flight plan is assigned. The operation device activates the unmanned aircraft in accordance with the flight plan. The operation device transmits an operation signal for operating the unmanned aircraft to the activated unmanned aircraft.

The flight management device shares shared information with the unmanned aircraft to be managed. The flight management device acquires transmission information transmitted from the unmanned aircraft that flies according to the flight plan and updates the shared information.

The flight management system of the present example embodiment shares shared information including transmission information of an unmanned aircraft and flight plan information between the unmanned aircraft that flies according to a flight plan and a flight management device that manages the unmanned aircraft. Therefore, according to the present example embodiment, by updating the shared information as needed according to the transmission information transmitted from the unmanned aircraft, the flight management device can accurately manage the flight situation of the unmanned aircraft. According to the present example embodiment, the unmanned aircraft can more safely fly on the flight route by autonomously controlling the unmanned aircraft in accordance with the positional relationship with the another unmanned aircraft flying around the unmanned aircraft.

In an aspect of the present example embodiment, the unmanned aircraft determines whether the flight plan is allowed to be executed according to the situation recognized by the sensor mounted on the unmanned aircraft. In a case where it is determined that the unmanned aircraft can execute the flight plan, the unmanned aircraft continues flight according to the flight plan. In a case where it is determined that the unmanned aircraft cannot execute the flight plan, the unmanned aircraft executes control different from the flight plan, and transmits a notification that the control different from the flight plan has been executed to the flight management device. According to the present aspect, autonomous control is performed according to the situation recognized by the sensor mounted on the unmanned aircraft, so that the unmanned aircraft can fly on the flight route more safely.

In an aspect of the present example embodiment, the unmanned aircraft determines whether the unmanned aircraft can be autonomously controlled according to a situation recognized by a sensor mounted on the unmanned aircraft. In a case where it is determined that the autonomous control is allowed to be executed, the unmanned aircraft executes the autonomous control. In a case where it is determined that the autonomous control is not allowed to be executed, the unmanned aircraft executes the emergency landing control, and transmits a notification that the emergency landing control has been executed to the flight management device. According to the present aspect, in a case where it is determined that the autonomous control is impossible according to the situation recognized by the sensor mounted on the unmanned aircraft, it is possible to avoid danger such as a crash by the unmanned aircraft autonomously making an emergency landing.

### Fourth Example Embodiment

Next, a flight management system according to a fourth example embodiment will be described with reference to the drawings. The flight management system of the present example embodiment has a configuration in which the flight management systems according to the first to third example embodiments are simplified.

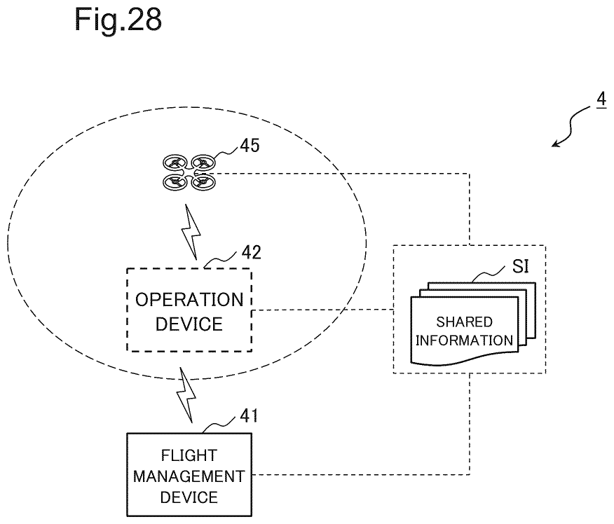

FIG. 28 is a conceptual diagram illustrating an example of a configuration of the flight management system 4 according to the present example embodiment. The flight management system 4 manages flight of an unmanned aircraft 45 that flies according to the flight plan. A flight management system 4 includes a flight management device 41 and at least one unmanned aircraft 45. FIG. 28 illustrates an operation device 42 that mediates communication between the flight management device 41 and the unmanned aircraft 45.

The unmanned aircraft 45 holds shared information in which transmission information including identification information, position information, and time information of the unmanned aircraft is associated with flight plan information including a flight plan. The unmanned aircraft 45 flies according to the flight plan while transmitting transmission information at a predetermined timing.

The flight management device 41 shares shared information with the unmanned aircraft 45 to be managed. The flight management device 41 acquires transmission information transmitted from the unmanned aircraft 45 that flies according to the flight plan and updates the shared information.

As described above, the flight management system of the present example embodiment shares shared information including transmission information of the unmanned aircraft and flight plan information between the unmanned aircraft that flies according to the flight plan and the flight management device that manages the unmanned aircraft. The flight management device can accurately manage the flight situation of the unmanned aerial vehicle by updating the shared information as needed according to the transmission information transmitted from the unmanned aircraft.

### (Hardware)

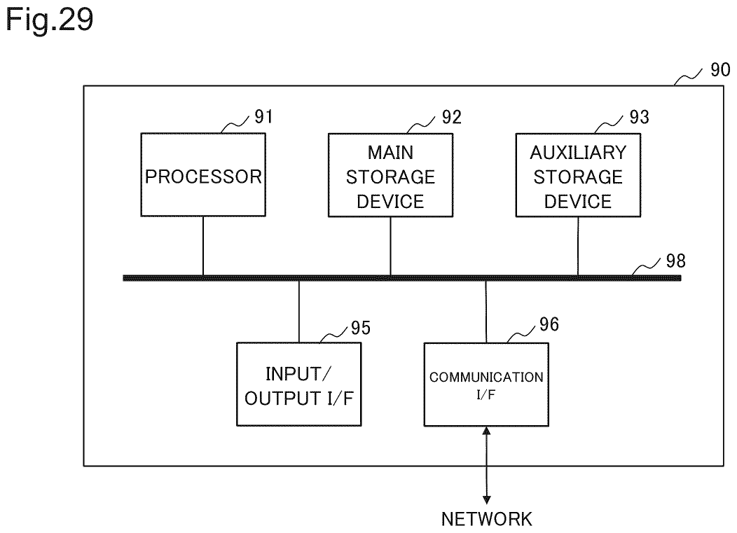

A hardware configuration for executing control and process according to each example embodiment of the present disclosure will be described using an information processing device 90 of FIG. 29 as an example. The information processing device 90 in FIG. 29 is a configuration example for performing control and a process of each example embodiment, and does not limit the scope of the present disclosure.

As illustrated in FIG. 29, the information processing device 90 includes a processor 91, a main storage device 92, an auxiliary storage device 93, an input/output interface 95, and a communication interface 96. In FIG. 29 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92. The processor 91 executes the program developed in the main storage device 92. In the present example embodiment, a software program installed in the information processing device 90 may be used. The processor 91 executes control and process according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). A nonvolatile memory such as a magnetoresistive random access memory (MRAM) may be configured and added as the main storage device 92.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. The input/output interface 95 and the communication interface 96 may be shared as an interface connected to an external device.

An input equipment such as a keyboard, a mouse, or a touch panel may be connected to the information processing device 90 as necessary. The input equipment is used to input of information and settings. In a case where the touch panel is used as the input device, the display screen of the display device may also serve as the interface of the input device. Data communication between the processor 91 and the input device may be mediated by the input/output interface 95.

The information processing device 90 may be provided with a display device that displays information. In a case where a display device is provided, the information processing device 90 preferably includes a display control device (not illustrated) that controls display of the display device. The display device may be connected to the information processing device 90 via the input/output interface 95.

The information processing device 90 may be provided with a drive device. The drive device mediates reading of data and a program from the recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for enabling control and process according to each example embodiment of the present invention. The hardware configuration of FIG. 29 is an example of a hardware configuration for executing control and process according to each example embodiment, and does not limit the scope of the present invention. A program for causing a computer to execute control and process according to each example embodiment is also included in the scope of the present invention. A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components of each example embodiment may be combined in any manner. The components of each example embodiment may be achieved by software or may be achieved by a circuit.

While the present invention is described with reference to example embodiments thereof, the present invention is not limited to these example embodiments. Various modifications that can be understood by those of ordinary skill in the art can be made to the configuration and details of the present invention within the scope of the present invention.

Some or all of the above example embodiments may be described as the following Supplementary Notes, but are not limited to the following.

### (Supplementary Note 1)

A flight management system that manages flight of an unmanned aircraft flying according to a flight plan, the flight management system including
at least one unmanned aircraft that holds shared information in which transmission information including identification information, position information, and time information about the unmanned aircraft and flight plan information including a flight plan are associated with each other and that flies according to the flight plan while transmitting the transmission information at a predetermined timing, and
a flight management device that shares the shared information with the unmanned aircraft to be managed and that acquires the transmission information transmitted from the unmanned aircraft flying according to the flight plan to update the shared information.

### (Supplementary Note 2)

The flight management system according to Supplementary Note 1, wherein the flight plan information includes identification information, a departure place, a scheduled departure time, a destination place, and a scheduled arrival time of the flight plan.

### (Supplementary Note 3)

The flight management system according to Supplementary Note 2, wherein
the flight plan information includes identification information of a flight route from the departure place to the destination place, and
the flight management device
manages flight of the unmanned aircraft assigned to the flight plan in accordance with the identification information of the flight route.

### (Supplementary Note 4)

The flight management system according to any one of Supplementary Notes 1 to 3, further including
an operation device that assigns the flight plan included in the flight plan information to the unmanned aircraft to be managed in response to an input of the flight plan information, generates the shared information in which the transmission information of the unmanned aircraft to which the flight plan is assigned and the flight plan information are associated with each other, transmits the generated shared information to the flight management device, and transmits the flight plan information to the unmanned aircraft to which the flight plan is assigned, wherein
the operation device
activates the unmanned aircraft in accordance with the flight plan, and
transmits an operation signal for operating the unmanned aircraft to the activated unmanned aircraft.

### (Supplementary Note 5)

The flight management system according to Supplementary Note 4, wherein
the operation device
generates update information of the flight plan in accordance with a change in the flight plan, and
transmits the generated update information of the flight plan to the flight management device and the unmanned aircraft.

### (Supplementary Note 6)

The flight management system according to Supplementary Note 4 or 5, wherein
the operation device
acquires the transmission information transmitted from the unmanned aircraft flying according to the flight plan,
updates the shared information using the acquired transmission information, and
transmits the acquired transmission information to the flight management device.

### (Supplementary Note 7)

The flight management system according to any one of Supplementary Notes 4 to 6, wherein
the operation device
receives the transmission information transmitted from a plurality of the unmanned aircrafts flying according to the flight plan, and
transmits a guidance signal for changing a positional relationship of the plurality of unmanned aircrafts to each of the plurality of unmanned aircrafts according to the position information included in the transmission information transmitted from each of the plurality of unmanned aircrafts.

### (Supplementary Note 8) (Third Example Embodiment)

The control device according to any one of Supplementary Notes 1 to 7, wherein
the unmanned aircraft
receives the transmission information transmitted from another unmanned aircraft flying around the unmanned aircraft,
calculates a control target position for providing a distance from the another unmanned aircraft in accordance with the position information included in the received transmission information, and
performs control to move the unmanned aircraft toward the calculated control target position.

### (Supplementary Note 9)

The control device according to any one of Supplementary Notes 1 to 8, wherein
the unmanned aircraft
determines whether the flight plan is allowed to be executed according to a situation recognized by a sensor mounted on the unmanned aircraft,
continues flight according to the flight plan in a case where it is determined that the flight plan is allowed to be executed,
executes control different from the flight plan in a case where it is determined that the flight plan is not allowed to be executed, and
transmits a notification that control different from the flight plan has been executed to the flight management device.

### (Supplementary Note 10)

The control device according to Supplementary Note 9, wherein
the unmanned aircraft
determines whether the unmanned aircraft allowed to be autonomously controlled according to a situation recognized by the sensor mounted on the unmanned aircraft,
in a case where it is determined that the autonomous control is allowed to be executed,
executes the autonomous control,
in a case where it is determined that the autonomous control is not allowed to be executed,
executes emergency landing control, and
transmits a notification that the emergency landing control has been executed to the flight management device.

### (Supplementary Note 11)

A flight management method of managing flight of an unmanned aircraft that flies according to a flight plan, the flight management method including
by a flight management device,
sharing shared information in which transmission information including identification information, position information, and time information about the unmanned aircraft to be managed and flight plan information including a flight plan are associated with each other with the unmanned aircraft,
acquiring the transmission information transmitted from the unmanned aircraft that flies according to the flight plan while transmitting the transmission information at a predetermined timing, and
updating the shared information using the acquired transmission information.

### (Supplementary Note 12)

A program for managing flight of an unmanned aircraft that flies according to a flight plan, the program causing a computer to execute the steps of
sharing shared information in which transmission information including identification information, position information, and time information about the unmanned aircraft to be managed and flight plan information including a flight plan are associated with each other with the unmanned aircraft,
acquiring the transmission information transmitted from the unmanned aircraft that flies according to the flight plan while transmitting the transmission information at a predetermined timing, and
updating the shared information using the acquired transmission information.

### REFERENCE SIGNS LIST

1, 2, 3, 4 flight management system
11, 21, 31, 41 flight management device
12, 22, 32, 42 operation device
15, 25, 35, 45 unmanned aircraft
120, 220, 320 relay
121 flight plan input unit
122 flight plan management unit
123 storage unit
124 first communication unit
125 operation signal acquisition unit
126 second communication unit
151 main body
152 propeller
153 motor
154 control unit
155 communication unit
156 storage unit
157 remote ID device
158 sensor
159 camera
160 rechargeable battery

What is claimed is:

1. A flight management system that manages flight of an unmanned aircraft flying according to a flight plan, the flight management system comprising:
at least one unmanned aircraft that holds shared information in which transmission information including identification information, position information, and time information about the unmanned aircraft and flight plan information including a flight plan are associated with each other and that flies according to the flight plan while transmitting the transmission information at a predetermined timing; and
a flight management device that comprises
a memory storing instructions, and
a processor connected to the memory and configured to execute the instructions to
share the shared information with the unmanned aircraft to be managed, and
acquire the transmission information transmitted from the unmanned aircraft flying according to the flight plan to update the shared information.

2. The flight management system according to claim 1, wherein
the flight plan information includes identification information, a departure place, a scheduled departure time, a destination place, and a scheduled arrival time of the flight plan.

3. The flight management system according to claim 2, wherein
the flight plan information includes identification information of a flight route from the departure place to the destination place, and
the processor of the flight management device is configured to execute the instructions to
manage flight of the unmanned aircraft assigned to the flight plan in accordance with the identification information of the flight route.

4. The flight management system according to claim 1, further comprising
an operation device that comprises
a memory storing instructions, and
a processor connected to the memory and configured to execute the instructions to
assign the flight plan included in the flight plan information to the unmanned aircraft to be managed in response to an input of the flight plan information,
generate the shared information in which the transmission information of the unmanned aircraft to which the flight plan is assigned and the flight plan information are associated with each other,
transmit the generated shared information to the flight management device, and
transmit the flight plan information to the unmanned aircraft to which the flight plan is assigned, wherein
the processor of the operation device is configured to execute the instructions to
activate the unmanned aircraft in accordance with the flight plan, and
transmit an operation signal for operating the unmanned aircraft to the activated unmanned aircraft.

5. The flight management system according to claim 4, wherein
the processor of the operation device is configured to execute the instructions to
generate update information of the flight plan in accordance with a change in the flight plan, and
transmit the generated update information of the flight plan to the flight management device and the unmanned aircraft.

6. The flight management system according to claim 4 or 5, wherein
the processor of the operation device is configured to execute the instructions to
acquire the transmission information transmitted from the unmanned aircraft flying according to the flight plan,
update the shared information using the acquired transmission information, and
transmit the acquired transmission information to the flight management device.

7. The flight management system according to claim 4, wherein
the processor of the operation device is configured to execute the instructions to
receive the transmission information transmitted from a plurality of the unmanned aircrafts flying according to the flight plan, and
transmit a guidance signal for changing a positional relationship of the plurality of unmanned aircrafts to each of the plurality of unmanned aircrafts according to the position information included in the transmission information transmitted from each of the plurality of unmanned aircrafts.

8. The flight management system according to claim 1, wherein
the unmanned aircraft that includes
a memory storing instructions, and
a processor connected to the memory and is configured to execute the instructions to
receive the transmission information transmitted from another unmanned aircraft flying around the unmanned aircraft,
calculate a control target position for providing a distance from the another unmanned aircraft in accordance with the position information included in the received transmission information, and
perform control to move the unmanned aircraft toward the calculated control target position.

9. The flight management system according to claim 1, wherein
the processor of the unmanned aircraft is configured to execute the instructions to
determine whether the flight plan is allowed to be executed according to a situation recognized by a sensor mounted on the unmanned aircraft,
continue flight according to the flight plan in a case where it is determined that the flight plan is allowed to be executed,
execute control different from the flight plan in a case where it is determined that the flight plan is not allowed to be executed, and
transmit a notification that the control different from the flight plan has been executed to the flight management device.

10. The flight management system according to claim 9, wherein
the processor of the unmanned aircraft is configured to execute the instructions to
determine whether the unmanned aircraft allowed to be autonomously controlled according to a situation recognized by the sensor mounted on the unmanned aircraft,
in a case where it is determined that the autonomous control is allowed to be executed,
execute the autonomous control,
in a case where it is determined that the autonomous control is not allowed to be executed,
execute emergency landing control, and
transmit a notification that the emergency landing control has been executed to the flight management device.

11. A flight management method of managing flight of an unmanned aircraft that flies according to a flight plan, the flight management method comprising:
by a computer,
sharing shared information in which transmission information including identification information, position information, and time information about the unmanned aircraft to be managed and flight plan information including a flight plan are associated with each other with the unmanned aircraft;
acquiring the transmission information transmitted from the unmanned aircraft that flies according to the flight plan while transmitting the transmission information at a predetermined timing; and
updating the shared information using the acquired transmission information.

12. A non-transitory recording medium storing a program for managing flight of an unmanned aircraft that flies according to a flight plan, the program causing a computer to execute:
processing of sharing shared information in which transmission information including identification information, position information, and time information about the unmanned aircraft to be managed and flight plan information including a flight plan are associated with each other with the unmanned aircraft;
processing of acquiring the transmission information transmitted from the unmanned aircraft that flies according to the flight plan while transmitting the transmission information at a predetermined timing; and
processing of updating the shared information using the acquired transmission information.

13. The flight management method according to claim 11, wherein
the flight plan information includes identification information, a departure place, a scheduled departure time, a destination place, and a scheduled arrival time of the flight plan.

14. The flight management method according to claim 13, wherein
the flight plan information includes identification information of a flight route from the departure place to the destination place, and
managing flight of the unmanned aircraft assigned to the flight plan in accordance with the identification information of the flight route.

15. The flight management method according to claim 11, wherein
assigning the flight plan included in the flight plan information to the unmanned aircraft to be managed in response to an input of the flight plan information,
generating the shared information in which the transmission information of the unmanned aircraft to which the flight plan is assigned and the flight plan information are associated with each other, and
transmitting the generated shared information to the flight management device, and transmit the flight plan information to the unmanned aircraft to which the flight plan is assigned, and wherein
activating the unmanned aircraft in accordance with the flight plan, and
transmitting an operation signal for operating the unmanned aircraft to the activated unmanned aircraft.

16. The flight management method according to claim 15, wherein
generating update information of the flight plan in accordance with a change in the flight plan, and
transmitting the generated update information of the flight plan to the flight management device and the unmanned aircraft.

17. The non-transitory recording medium according to claim 12, wherein
the flight plan information includes identification information, a departure place, a scheduled departure time, a destination place, and a scheduled arrival time of the flight plan.

18. The non-transitory recording medium according to claim 17, wherein
the flight plan information includes identification information of a flight route from the departure place to the destination place, and
the program causing the computer to execute
managing flight of the unmanned aircraft assigned to the flight plan in accordance with the identification information of the flight route.

19. The flight management method according to claim 12, wherein
the program causing the computer to execute
assigning the flight plan included in the flight plan information to the unmanned aircraft to be managed in response to an input of the flight plan information,
generating the shared information in which the transmission information of the unmanned aircraft to which the flight plan is assigned and the flight plan information are associated with each other, and
transmitting the generated shared information to the flight management device, and transmit the flight plan information to the unmanned aircraft to which the flight plan is assigned, and wherein
activating the unmanned aircraft in accordance with the flight plan, and
transmitting an operation signal for operating the unmanned aircraft to the activated unmanned aircraft.

20. The flight management system according to claim 19, wherein
the program causing the computer to execute
generating update information of the flight plan in accordance with a change in the flight plan, and
transmitting the generated update information of the flight plan to the flight management device and the unmanned aircraft.
